(19) United States
(12) Patent Application Publication
(10) Pub. No.: US 2023/0349135 A1
(43) Pub. Date: Nov. 2, 2023

(54) A DEVICE FOR HOLDING A SHOWER HEAD

(71) Applicants: Michael CORNISH, Melbourne (AU); AUCURO PTY LTD, Melbourne (AU)

(72) Inventor: Michael William Cornish, Melbourne (AU)

(21) Appl. No.: 18/025,626

(22) PCT Filed: Sep. 8, 2021
(86) PCT No.: PCT/AU2021/051043

§ 371 Date: Mar. 9, 2023

(30) Foreign Application Priority Data
Sep. 10, 2020 (AU) 2020903256

(51) Int. Cl. E03C 1/06; B05B 15/628

(52) U.S. Cl. CPC E03C 1/063; B05B 15/628

(57) ABSTRACT

A device for holding a shower head, the device comprising a base connectable to a support; an arm connected to the base and configured to move with respect to the base about a first axis and about a second axis, wherein the first axis is generally perpendicular to the second axis; an extension member supported by the arm and configured to extend relative to the arm; and a holder connected to the extension member and configured to hold the shower head.

### FIELD OF THE INVENTION

The present invention relates to a device for holding a shower head or hand shower so as to assist a user with bathing.

### BACKGROUND OF THE INVENTION

Some people suffer from certain disabilities or have certain limitations that make it difficult for them to shower. In some cases, a person's disabilities or limitations may prevent them from showering without assistance from another person.

For situations of this sort, it is known to use an assistive device for assisting with showering. The assistive device may be used by the person to be showered and/or by a person who is assisting the person to be showered. Examples of such devices are disclosed in Japanese patent application publications JP 2005188172 and JPH 09209425. In general, these devices include, at one end, a mount to mount the device to a frame, a post, a rail, or another fixture located in the bathroom or shower and, at another end, a holder adapted to hold a shower head or hand shower. The devices may be adapted to extend and/or rotate with respect to the mount so as to enable convenient placement of the shower head for showering.

It is an object of the present invention to provide an improved shower head holding device or at least provide a useful alternative to prior shower head holders.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In an aspect, the present invention provides a device for holding a shower head, the device comprising:
a base connectable to a support;
an arm connected to the base and configured to move with respect to the base about a first axis and about a second axis, wherein the first axis is generally perpendicular to the second axis;
an extension member supported by the arm and configured to extend relative to the arm; and
a holder connected to the extension member and configured to hold the shower head.

The device preferably further includes an adapter connectable to the shower head and receivable by the holder so as to secure the shower head to the holder. The adapter is preferably configured to releasably secure the shower head to the holder. Preferably, the adapter is configured to prevent accidental or unintended removal of the shower head from the holder. More preferably, the adapter is configured to allow removal of the shower head from the holder only when a release means is selectively actuated. The adapter is preferably receivable at least partially within the holder. The adapter preferably acts as an interface between the shower head and the holder.

In an embodiment, the adapter is connectable about an arm or conduit extending from a rose of the shower head. In another embodiment, the adapter is connectable in line between the arm or conduit and a hose of the shower head. In another embodiment, the adapter is connectable in line between a first portion of the arm or conduit and a second portion of the arm or conduit. The adapter may include a bore extending therethrough to enable fluid to flow through the adapter from a first end to a second end thereof.

The adapter may be threadably connected in line between the arm or conduit and the hose of the shower head, or threadably connected in line between the first and second portions of the arm or conduit. In one embodiment, the adapter may include a first thread at the first end that is configured to threadably connect to the arm or conduit of the shower head, and a second thread at the second end that is configured to threadably connect to the hose. In another embodiment, the first thread is configured to be threadably connected to the first portion of the arm or conduit, and the second thread is configured to be threadably connected to the second portion of the arm or conduit. In these embodiments, the adapter is configured to receive and pass fluid from the hose to the arm or conduit, or receive and pass fluid from the second portion to the first portion of the arm or conduit. The fluid is configured to flow through the bore of the adapter.

The adapter preferably includes an element that is configured to engage within the holder to secure the shower head to the holder. In one embodiment, the element is a moveable element that is configured to releasably engage within a complementary aperture within the holder. The moveable element may be a pin. The pin is preferably biased to an extended position in which it is configured to engage within the complementary aperture to thereby secure the shower head to the holder. The pin may be biased to the extended position by a spring.

The adapter also preferably includes a release means that may be selectively actuated to allow for the removal of the shower head from the holder. The release means may comprise a pushable or pressable element that is configured to move the moveable element to a retracted position against its bias when the pushable or pressable element is actuated by pushing or pressing to thereby allow for the removal of the shower head from the holder. In one embodiment, the pushable or pressable element is thus configured to remove the pin from the aperture when the pushable or pressable element is actuated by pushing or pressing. In this manner, the shower head is releasably securable to the holder.

The pushable or pressable element is preferably biased to an unactuated position corresponding to the extended position of the pin. The pushable or pressable element may be biased to the unactuated position by a spring.

Advantageously, the adapter acts to releasably secure the shower head to the holder to prevent accidental or unintended removal of the shower head from the holder which may otherwise occur, for example, as the arm or extension member are moved during use.

The adapter may also include a locking mechanism that is configured to releasably lock the shower head to the holder. The locking mechanism is preferably configured to lock the pushable or pressable element in the unactuated position to thereby prevent removal of the pin from its extended position within the aperture.

The adapter may comprise a generally tubular sleeve and a laterally protruding portion that protrudes laterally from the generally tubular sleeve. The laterally protruding portion may be generally rectangular in cross-section. The generally tubular sleeve is adapted to receive a generally tubular element having a bore extending therethrough to enable fluid to flow through the adapter from a first end to a second end thereof. The generally tubular sleeve preferably includes the first and second threads such that the adapter can be threadably connected to the arm or conduit of the shower head, and the hose. The adapter may also include another locking mechanism that is configured to lock the orientation of tubular element with respect to the tubular sleeve of the adapter (and thus lock the orientation of the connected shower head with respect to the holder). The locking mechanism may comprise a threaded element configured to be moved between a non-locking position and a locking position. In the locking position, the threaded element may contact a portion of the tubular element to rotationally lock the tubular element with respect to the tubular sleeve of the adapter. In an embodiment, the locking mechanism may comprise a screw, such as a grub screw.

The holder is preferably configured to move with respect to the extension member. Preferably, the holder is configured to rotate with respect to the extension member about a third axis. The third axis is preferably generally perpendicular to the first and second axes. The third axis may be parallel to a longitudinal axis of the extension member. The holder is preferably rotatable 360° about the third axis.

In an alternative embodiment, the holder is connected to the extension member via a ball joint connection allowing relatively free rotation of movement. The opposite end of the extension member may also be connected to the base by a ball joint connection. In a preferred arrangement, the extension member may comprise two space apart longitudinal members joined by a clamping arrangement. The ball joint ball may be located on the holder, which is positioned between the two ends of the longitudinal members. The clamping arrangement may be loosened to allow free movement of the ball with respect to the longitudinal members, and then tightened to draw the two longitudinal members towards each other to clamp the sides of the ball, limiting its ability to rotate. The same arrangement may be located at the opposite end with respect to the base connection. The holder is preferably U-shaped in cross-section. The holder is configured to at least partially slidably receive the shower head and adapter.

The base preferably includes a mounting portion for mounting the device to the support. The support may be a frame, a post, a rail, or another fixture located in the bathroom or shower. In one embodiment, the mounting portion is preferably U-shaped in cross-section, which U-shape advantageously allows the mounting portion to be slidably connected about the support. The support may include a plurality of spaced-apart aligned apertures extending therealong that are adapted to interface with the base to thereby adjustably position the base with respect to the support. The base may include an engagement feature adapted to engage at least partially within a respective one of the plurality of spaced-apart aligned apertures to thereby set the position of the base relative to the support. The engagement feature may be biased to an extended position in which it is configured to engage at least partially within the respective one of the apertures. The engagement feature may lock the position of the base relative to the support when the engagement feature is located at least partially within the respective one of the apertures. The engagement feature may be a pin. The pin may be biased by a spring to the extended position, and may be retracted against the bias to a retracted position in which the pin does not engage within the respective one of the apertures.

The mounting portion is preferably adapted to receive a resilient element that is moveable within a space defined by the U-shape to adjustably close the space. The moveable element is preferably configured to close the space to an appropriate extent such that the space is sized to complement the size of the support, such as the size of a diameter of the support. The moveable element may include a surface which is complementary to a surface of the support. In one embodiment, the surface is semi-circular in cross-section to thereby complement and engage an outer cylindrical surface of the support.

The mounting portion preferably further includes a closing device for securing the moveable element within a desired position within the space. Preferably, the closing device at least partially engages the moveable element to move the moveable element within the space. The closing device may be a knob that is rotatably receivable about a thread located at the mounting portion. The moveable element may be biased to a position in which it is configured to engage the support. Preferably, the moveable element maintains consistent at least partial contact with the support due to the bias. The bias may be provided by an element forming part of the closing device. The mounting portion may further include a safety element configured to prevent removal of the moveable element from the U-shaped space.

The arm may be connected to the base by a first connection which allows rotation of the arm with respect to the base about the first axis. The arm is preferably rotatable 360° about the first axis.

The arm may be further connected to the base about a second connection which allows rotation of the arm with respect to the base about the second axis. The arm may be rotatable 180° about the second axis. However, for reasons of safety, the second connection is preferably a pivot connection that allows the arm to pivot with respect to the base about the second axis in a range between 0° and approximately 40°.

The arm may be resiliently moveable with respect to the base about the first and second axes. Thus, the arm may be configured to maintain a position with respect to the base after movement to that position. The arm may alternatively be configured to be resiliently moveable about only one of the first and second axes, such as the first axis for example. The extension member may also be preferably resiliently moveable with respect to the arm such that the extension member is configured to maintain a position with respect to the arm after movement to that position.

The device preferably further includes one or more retarding mechanisms that act to retard the movement of the device. For example, the device may include a retarding mechanism that retards movement of the arm with respect to the base. The device may also include another retarding mechanism that retards movement of the extension member relative to the arm. The device may also include another retarding mechanism that retards movement of the holder relative to the extension member. The one or more retarding mechanisms of the device preferably act to slow the movement of the arm and/or extension member and/or the holder along their respective axes of movement. Advantageously, in this way, the one or more retarding mechanisms may, for example, provide resistance to movement of the arm if the arm is inadvertently moved. If the arm is inadvertently moved, such as by being bumped accidentally, the one or more retarding mechanisms act to resist the movement of the arm and thereby reduce the risk that the arm may injure a user or any other person.

In one form, the retarding mechanism may comprise a first element and a second element. The first element is preferably rotationally fixed within the device, and the second element preferably acts to cause the first element to at least partially contact a portion of the device to thereby retard movement of the device. In an embodiment, the first element may be one or more of a plate, a bushing, or a washer, and the second element may be one or more O-rings that interface with the first element. The device may further include a handle to assist with moving the arm and the extension member. The handle is preferably located at a distal end of the extension member such that the extension member can be readily extended or retracted relative to the arm.

The device may include a plurality of the arms described above. For example, the device may include a first arm and a second arm. The first and second arms may be substantially similar or the same. The first arm may be connected to the base and may be moveable with respect to the base about first and second generally perpendicular axes. Similarly, the second arm may be connected to the first arm and may be moveable with respect to the first arm about first and second generally perpendicular axes. The holder may be moveable connected to the second arm. The holder may be configured to rotate about a third axis that is generally perpendicular to each of the first and second axes.

In another aspect, the present invention provides a device for holding a shower head, the device comprising:
a base connectable to a support;
an arm connected to the base and configured to rotate with respect to the base about a first axis and about a second axis, wherein the first axis is generally perpendicular to the second axis;
an extension member supported by the arm and configured to extend relative to the arm;
a holder connected to the extension member and configured to hold the shower head; and
an adapter connectable to the shower head and receivable by the holder so as to secure the shower head to the holder.

The adapter according to this aspect of the invention may include any one or more of the features described above in relation to the adapter according to the aforementioned aspect of the invention.

The device according to this aspect of the invention may include any one or more of the features described above in relation to the device according to the aforementioned aspect of the invention.

In another aspect, the present invention provides a system comprising:
a shower head holder; and an adapter connectable to a shower head, wherein the adapter is connectable to the shower head and receivable by the shower head holder so as to secure the shower head to the shower head holder.

The adapter according to this aspect of the invention may include any one or more of the features described above in relation to the adapter according to any one of the aforementioned aspects of the invention.

The shower head holder according to this aspect of the invention may include any one or more of the features described above in relation to the device according to any one or more of the aforementioned aspects of the invention.

In another aspect, the present invention provides a kit of components comprising:
a shower head holder; and an adapter connectable to a shower head, wherein the adapter is connectable to the shower head and receivable by the shower head holder so as to secure the shower head to the shower head holder.

The adapter according to this aspect of the invention may include any one or more of the features described above in relation to the adapter according to any one of the aforementioned aspects of the invention.

The shower head holder according to this aspect of the invention may include any one or more of the features described above in relation to the device according to any one or more of the aforementioned aspects of the invention.

In another aspect, the present invention provides a method of securing a shower head to a shower head holder, the method comprising:
connecting an adapter to the shower head; connecting the adapter to the shower head holder to thereby secure the shower head to the shower head holder.

The adapter according to this aspect of the invention may include any one or more of the features described above in relation to the adapter according to any one of the aforementioned aspects of the invention.

The shower head holder according to this aspect of the invention may include any one or more of the features described above in relation to the device according to any one or more of the aforementioned aspects of the invention.

In another aspect, the present invention provides an adapter configured to secure a shower head to a shower head holder, the adapter comprising:
a body configured to be connected to the shower head; and an element configured to engage the shower head holder to thereby secure the shower head to the shower head holder.

The element is preferably a moveable element that is configured to move between an extended position in which it engages the shower head holder, and a retracted position. The moveable element preferably engages an aperture or recess in the shower head holder to thereby secure the shower head to the shower head holder. In one embodiment, the moveable element is a pin that is configured to engage within a complementary aperture within the shower head holder. The pin is preferably biased to the extended position. The pin may be biased to the extended position by a spring.

The adapter may further include a pushable or pressable element that is configured to move the moveable element to the retracted position against its bias when the pushable or pressable element is actuated by pushing or pressing.

In an embodiment, the body is connectable about an arm or conduit extending from a rose of the shower head. In another embodiment, the body is connectable in line between the arm or conduit and a hose of the shower head. In another embodiment, the body is connectable in line between a first portion of the arm or conduit and a second portion of the arm or conduit. The body may include a bore extending therethrough to enable fluid to flow through the body from a first end to a second end thereof.

The adapter according to this aspect of the invention may further include any one or more of the features described above in relation to the adapter according to any one of the aforementioned aspects of the invention.

In another aspect, the present invention provides a device for holding a shower head, the device comprising:
a base connectable to a support;
a first arm connected to the base and configured to move with respect to the base about respective first and second generally perpendicular axes;
a second arm connected to the first arm and configured to move with respect to the first arm about respective first and second generally perpendicular axes; and
a holder connected to the second arm and configured to hold the shower head.

The respective first axes of the first and second arms may be parallel to one another. The respective second axes of the first and second arms may be parallel to one another.

The holder may be movably connected to the second arm. In a preferred embodiment, the holder is configured to rotate with respect to the second arm about a third axis. The third axis may be generally perpendicular to a longitudinal axis of the second arm. The holder may be further configured to rotate with respect to the second arm about a fourth axis. The fourth axis may be generally parallel to the longitudinal axis of the second arm. The holder may connected to the second arm by a pivot connection that allows the holder to move with respect to the second arm about the third axis.

In an alternative embodiment, the holder is connected to the extension member via a ball joint connection allowing relatively free rotation of movement. The opposite end of the extension member may also be connected to the base by a ball joint connection. In a preferred arrangement, the extension member may comprise two space apart longitudinal members joined by a clamping arrangement. The ball joint ball may be located on the holder, which is positioned between the two ends of the longitudinal members. The clamping arrangement may be loosened to allow free movement of the ball with respect to the longitudinal members, and then tightened to draw the two longitudinal members towards each other to clamp the sides of the ball, limiting its ability to rotate. The same arrangement may be located at the opposite end with respect to the base connection.

The device according to this aspect of the invention may include any one or more of the features described above in relation to the devices according to the aforementioned aspects of the invention. In another aspect, the invention provides a shower system including a first device according to any of the disclosed aspects together with a second device according to any of the disclosed aspects, co-located on a rail, each independently movable with respect to the rail.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 is a perspective view of a device for holding a shower head according to an embodiment of the invention, wherein the device is located in situ within a bathroom;

FIG. 2 is a perspective view of the device of FIG. 1;

FIG. 3 is another perspective view of the device of FIG. 1;

FIG. 4 is another perspective view of the device of FIG. 1;

FIG. 5A is another perspective view of the device of FIG. 1, and shows a range of movement of the device in dotted outline;

FIG. 5B is another perspective view of the device of FIG. 1, and shows a range of movement of a holder of the device;

FIG. 6A is an exploded view of an adapter that connects the shower head to the device to of FIG. 1;

FIG. 6B is a view of another shower head and an alternative adapter that may be used to connect the shower head to the device of FIG. 1;

FIG. 6C is a view of another shower head and another alternative adapter that may be used to connect the shower head to the device of FIG. 1;

FIG. 6D is a view of another shower head and another alternative adapter that may be used to connect the shower head to the device of FIG. 1;

FIG. 7 is similar to FIG. 6A, but shows the adapter connected to the shower head;

FIG. 8 is a perspective view of the adapter of FIG. 6A;

FIG. 9 is a side view of the adapter of FIG. 6A;

FIG. 10A is a partial cross-sectional view of the adapter of FIG. 6A;

FIG. 10B is a partial cross-sectional view of the device of FIG. 1, and shows the adapter of FIG. 6A engaging within the holder to secure the shower head to the device of FIG. 1;

FIG. 10C is a cross-sectional view of the adapter of FIG. 6A;

FIG. 10D is a perspective view of the device of FIG. 1, and shows rotation of the shower head with respect to the holder;

FIG. 11 is a bottom-up view of a mounting portion of the device of FIG. 1;

FIG. 12 is similar to FIG. 11, but is a cross-sectional view;

FIG. 13 is similar to FIG. 12;

FIG. 14 is cross-sectional view of the holder and an extension member of the device of FIG. 1;

FIG. 15 is a cross-sectional view of an arm of the device of FIG. 1;

FIG. 16 is another cross-sectional view of the arm of the device of FIG. 1;

FIG. 17 is a side view of the device of FIG. 1, and shows that the shower head may be mounted either to the left or right of an arm of the device;

FIG. 18 is a cross-sectional view of an alternative mounting portion of the device of FIG. 1;

FIGS. 19A and 19B are similar to FIG. 18;

FIG. 20A is a perspective view of the device of FIG. 1 mounted to an alternative rail;

FIG. 20B is similar to FIG. 20A;

FIG. 21 is a rear perspective view of the device of FIGS. 20A and 20B;

FIG. 22 is a top-down cross-sectional of the device mounted to the rail of FIGS. 20A and 20B;

FIG. 23 is similar to FIG. 22;

FIG. 24 is a rear perspective view of the device of FIGS. 20A and 20B;

FIG. 25 is a partial cross-sectional view of the device of FIG. 24 mounted to the rail of FIGS. 20A and 20B;

FIG. 26A is similar to FIG. 25, but is a side cross-sectional view;

FIG. 26B is similar to FIG. 26A;

FIG. 27 is an alternative embodiment of the device of FIG. 1;

FIG. 28A is shows a further alternative embodiment of an upper device shown on a rail with a lower device of another embodiment holding a shower head;

FIG. 28B is the same as FIG. 28A with the shower head in the upper device;

FIGS. 29A and 29B show two perspective views of the device of FIG. 28A;

FIG. 30 is a cross-sectional side view of the base of FIG. 28A; and

FIG. 31 is a cross-sectional top view of the device of FIG. 28A.

### DETAILED DESCRIPTION OF THE EMBODIMENTS

It will be understood that the invention disclosed and defined in this specification extends to all alternative combinations of two or more of the individual features mentioned or evident from the text or drawings. All of these different combinations constitute various alternative aspects of the invention.

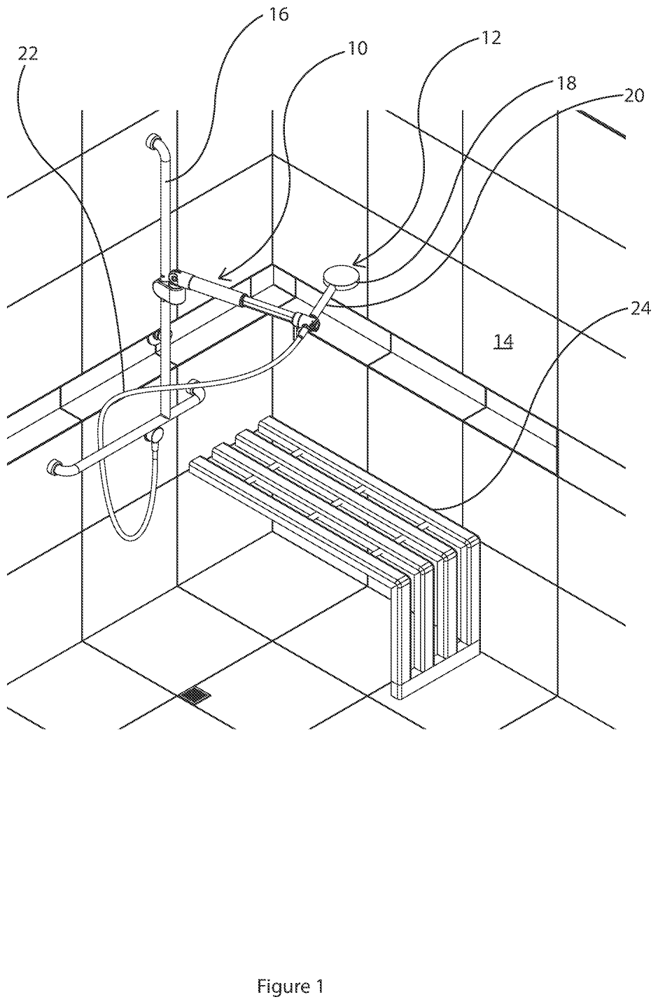

Referring to FIG. 1, there is shown a device 10 for holding a shower head 12. The device 10 is situated within a bathroom 14 and is removably mounted to a vertical support 16 in the form of a tubular rail extending from a wall of the bathroom 14. Advantageously, the device 10 allows for the shower head 12 to be located in a greater variety of desired positions than a typical shower head arrangement. In the illustrated embodiment, the shower head 12 comprises a rose 18 having a generally circular cross-section, a tubular conduit 20 extending from the rose 18, and a flexible hose 22 connected to the tubular conduit 20 via an adapter (discussed in detail below). As is typical in the art, the flexible hose 22 is connected through a wall of the bathroom to a water supply means to enable water to be supplied to the rose 18 via the flexible hose 22 and tubular conduit 20. As is described below, the adapter advantageously acts to releasably secure the shower head 12 to the device 10 to prevent accidental or unintended removal of the shower head 12 from the device 10. Moreover, the adapter is configured to allow removal of the shower head 12 from the device 10 only when a release means is selectively actuated. This is an advance over prior shower holder designs, which are prone to accidental removal of the shower head from the holder, typically when moving the holder to a desired position. As will be appreciated, accidental removal of the shower head from the holder can be potentially dangerous as the removed shower head may contact and injure the user. Furthermore, the user may not be able to reach a dropped shower head and/or the shower mixer controls after the shower head has been inadvertently removed from the holder.

The device 10 is particularly suited to be used by users that may be disabled or may have certain limitations that make it difficult for them to shower. As will be appreciated, the device 10 is configured to hold the shower head 12 in a variety of fixed positions as desired by the user, and is selectively moveable by hand to enable a new positioning of the device 10 to suit the requirements of the user. In the illustrated embodiment, the shower head 12 is located in a position that would readily enable a user to be showered whilst seated upon a bench 24 (or shower commode chair for example) situated within the bathroom 14. Advantageously, the device 10 may be readily operated by the person to be showered (i.e. the user) or by a person assisting the user.

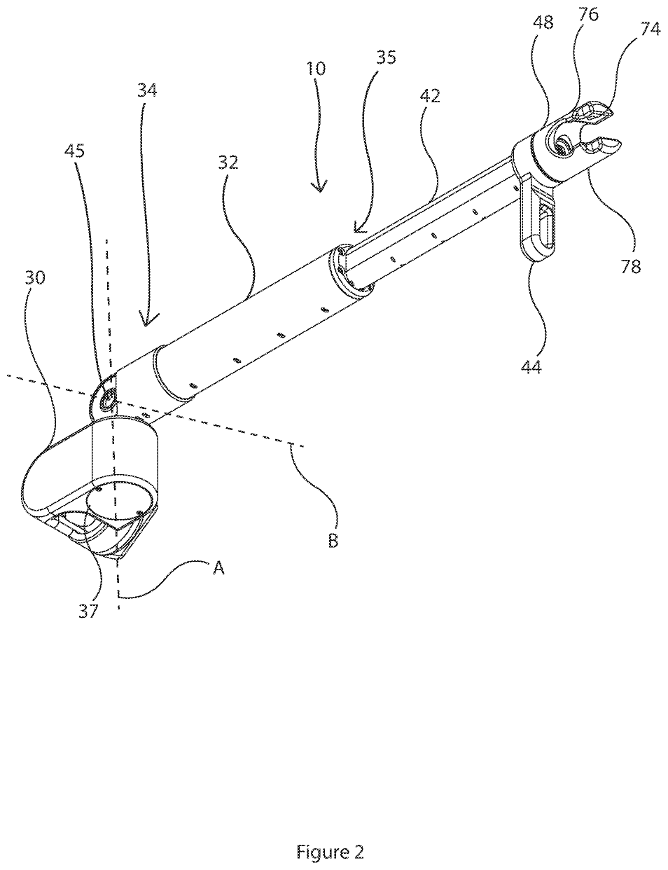

Referring to FIG. 2, the device 10 comprises a generally elongate base 30. In the manner described below, the base 30 is removably connectable to a support, such as a support rail 16 shown in FIG. 1. When connected, the base 30 is fixed relative to the support rail 16 and a distal end of the device 10 may be moved relative to the fixed base 30 and support rail 16.

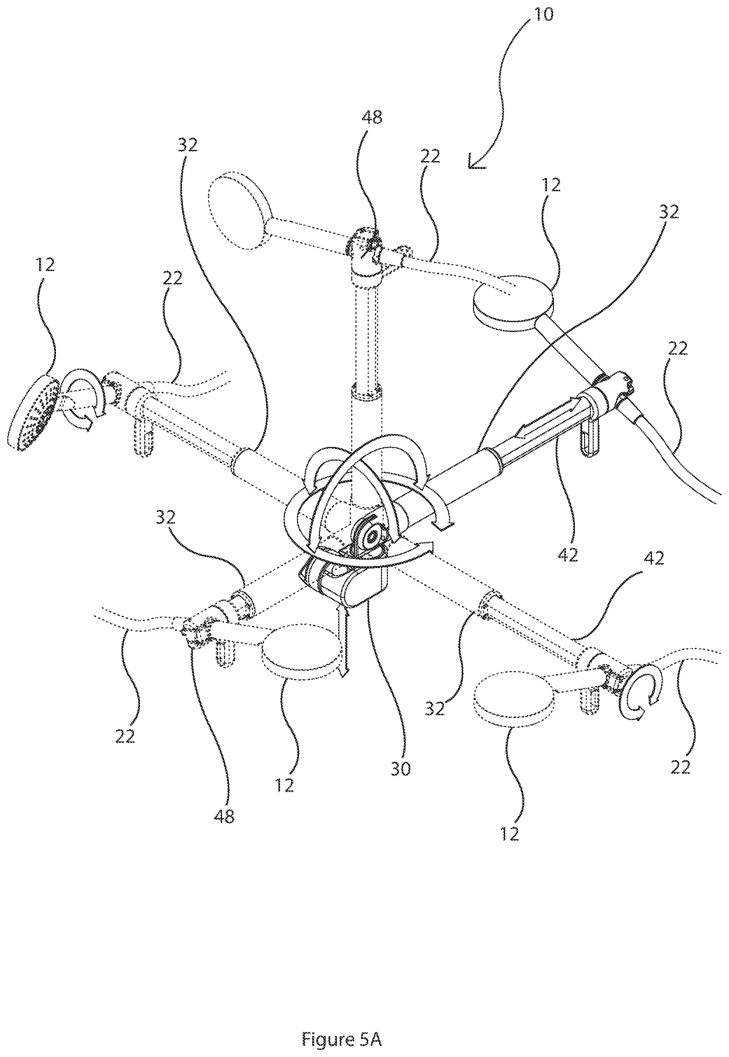

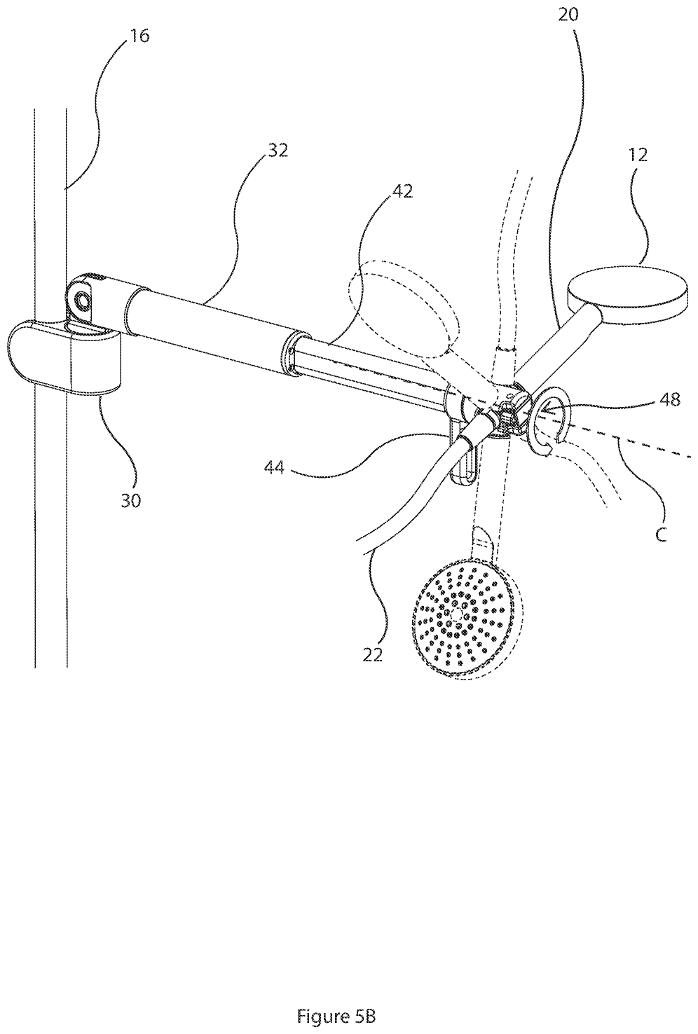

The device 10 further includes a generally tubular arm 32 connected to the base at a proximal end 34 thereof. The arm 32 is configured to move with respect to the base 30 about a first, generally vertical axis A, and further about a second, generally horizontal axis B, each of the axes A and B intersecting and extending through the proximal end 34 of the arm 32. In this manner, the arm 32 may be pitched relatively upwardly or downwardly about the axis B, and may be rotated to the left or right about axis A. This range of motion about two perpendicular axes A and B allows the arm 32 of the device 10 to be placed in a variety of desired positions, as is shown in dotted outline in FIG. 5A for example. The arm 32 may be configured to be rotatable 360° about the first, generally vertical axis A, and rotatable 180° about the second, generally horizontal axis B. However, for reasons of safety, the arm 32 may be specifically configured such that it is movable from a downmost or horizontal position to an uppermost inclined position about the axis B, which uppermost position is approximately 40° from the downmost position. The arm 32 is resiliently movable with respect to the base 30 about the axis A, and thus the arm 32 is configured to maintain a set position with respect to the base 30 after movement of the arm 32 to that set position about the axis A. In relation to movement about the axis B, the arm 32 is configured to be pitched relatively upwardly by hand force, and is further configured to move relatively slowly downwardly about the axis B if the arm 32 is left unsupported. Advantageously therefore, if the user stands up and accidentally contacts the arm 32, the arm 32 will pitch upwardly in the direction of movement of the user, and thereby potentially minimise injury.

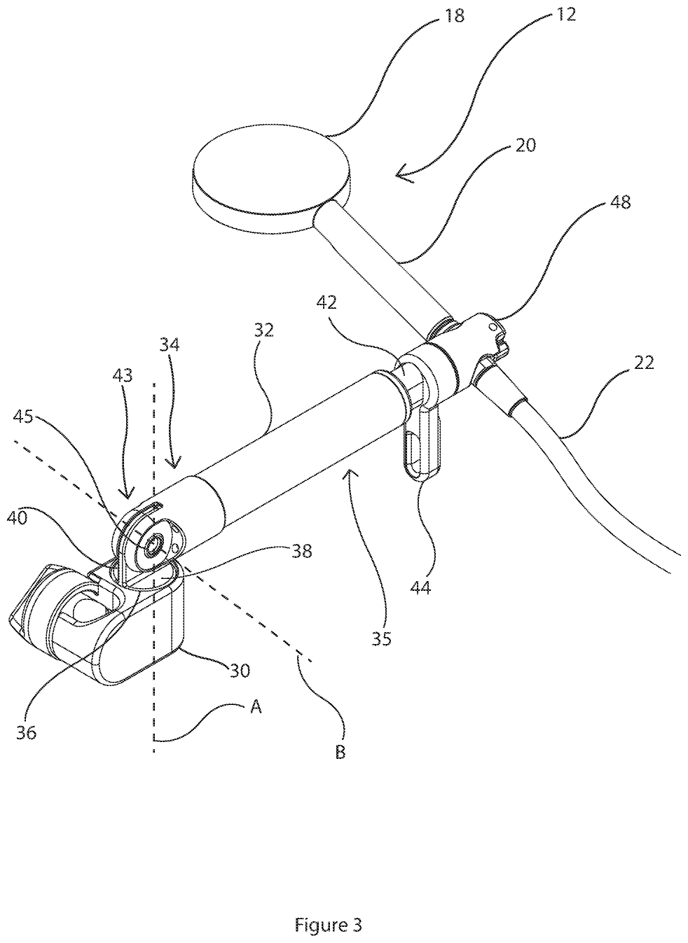

As is shown in FIGS. 2 and 3, the base 30 is elongate in overall form and comprises a pair of generally parallel long sides that are connected by generally semi-circular outwardly curved ends. The base 30 further includes a generally circular bore 36 extending vertically through the base 30 from an upper end to a lower end thereof, which bore 36 is located generally adjacent a distal one of the outwardly curved ends. The bore 36 is dimensioned to receive a general tubular bearing 38 (FIG. 3) located under a cover plate 37 (FIG. 2). The tubular bearing 38 is connected to the proximal end 34 of the arm 32 via an upwardly extending plate-like member 40 (FIG. 3) that is received within a forked end section 43 of the arm 32. As will be appreciated, the generally tubular bearing 38 enables the arm 32 to rotate about the axis A within the bore 36. As is shown in FIG. 3, the upwardly extending plate-like member 40 is fixed within the forked end section 43 of the arm 32 by a bearing 45 that enables rotation of the arm 32 upwardly and downwardly about the axis B relative to the plate-like member 40.

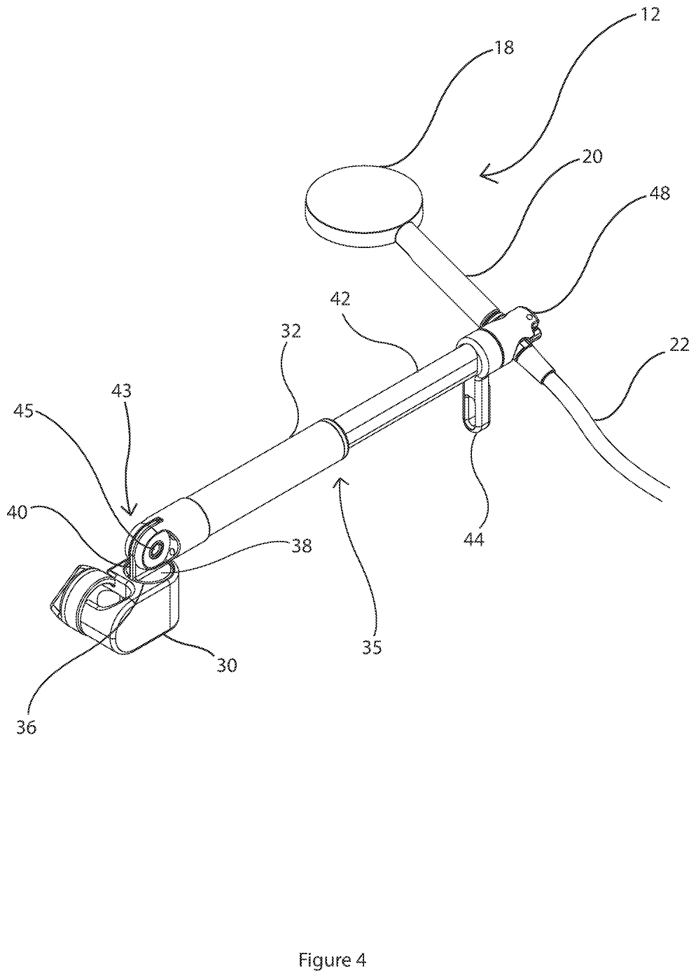

As is shown in FIG. 2, the tubular arm 32 supports a generally tubular extension member 42 that is extendable and retractable relative to a distal end 35 of the arm 32 to enable further flexibility in the positioning of the device 10. The extension member 42 is telescopically located within the arm 32, and may be slid relative to the arm 32 by grasping and pulling a handle 44 that extends generally downwardly from a distal end of the extension member 42 in a direction generally perpendicularly to a longitudinal axis of the extension member 42. FIG. 3 shows the extension member 42 in an innermost or retracted position relative to the distal end 35 of the arm 32, and FIG. 4 shows the extension member 42 in an outermost or extended position relative to the distal end 35 of the arm 32. FIG. 5A also shows the range of movement of the extension member 42 relative to the arm 32 in dotted outline. The extension member 42 is resiliently movable with respect to the arm 32 such that the extension member 42 is configured to maintain a set position with respect to the arm 32 after movement to that set position.

The device 10 further includes a holder 48 that is rotatably connected to the distal end of the extension member 42 and which is configured to hold the shower head 12 as is shown in FIG. 3 for example. As is shown in FIG. 2, the holder 48 is generally U-shaped in side cross-section and is thus configured to at least partially slidably receive the shower head 12 in the manner described below. Advantageously, the holder 48 is configured to move with respect to the extension member 42. Specifically, referring to FIG. 5B for example, the holder 48 is configured to rotate 360° about a third axis C that is generally parallel to a longitudinal axis of the extension member 42. The third axis C is arranged to be generally perpendicular each of the first and second axes A, B.

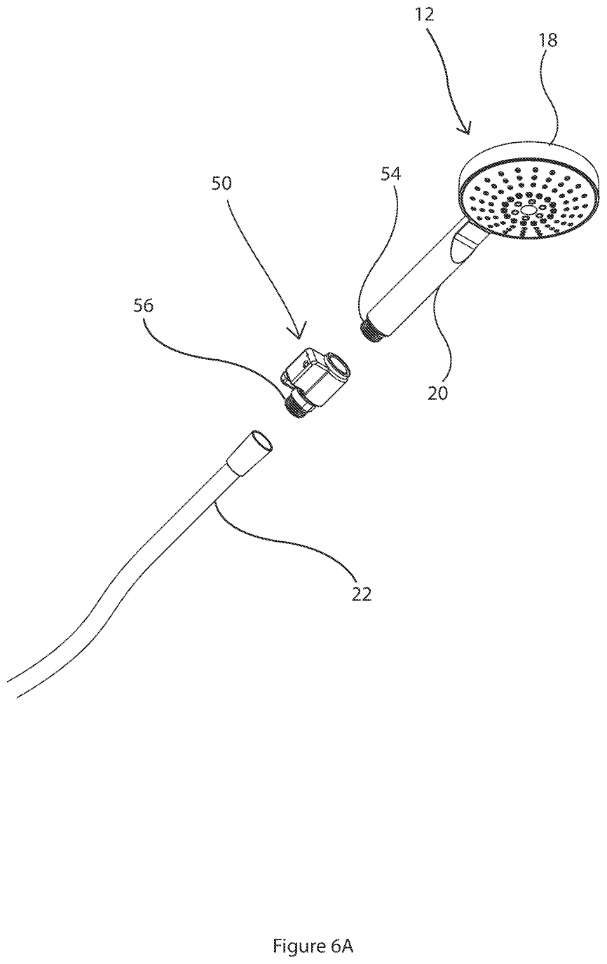

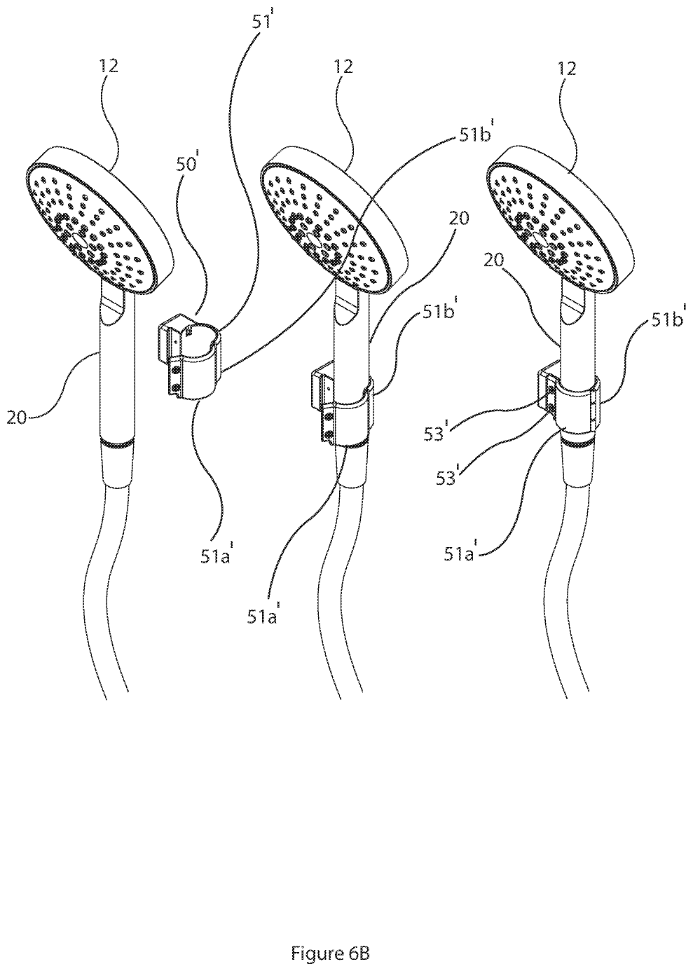

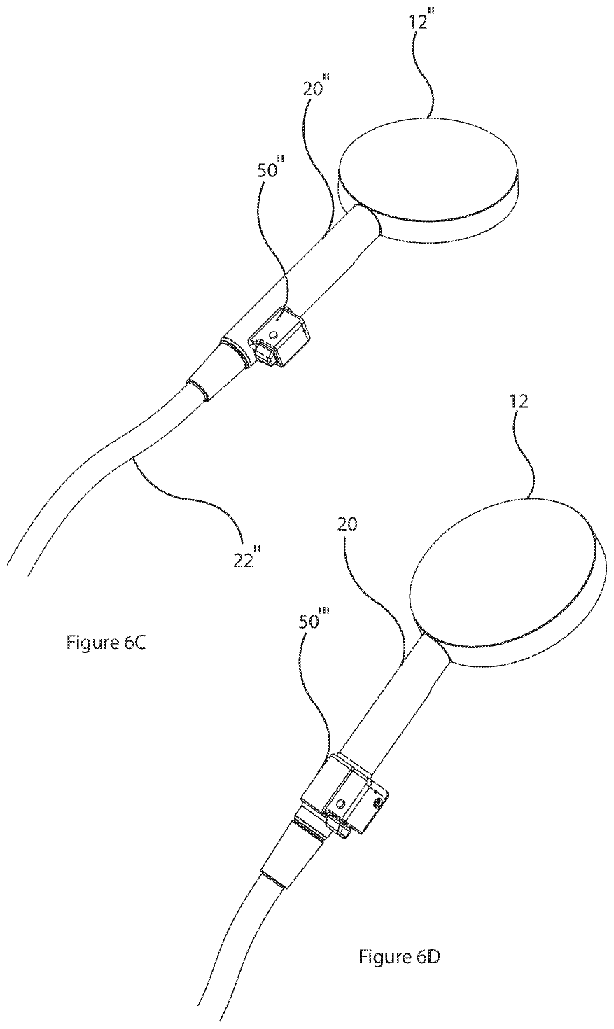

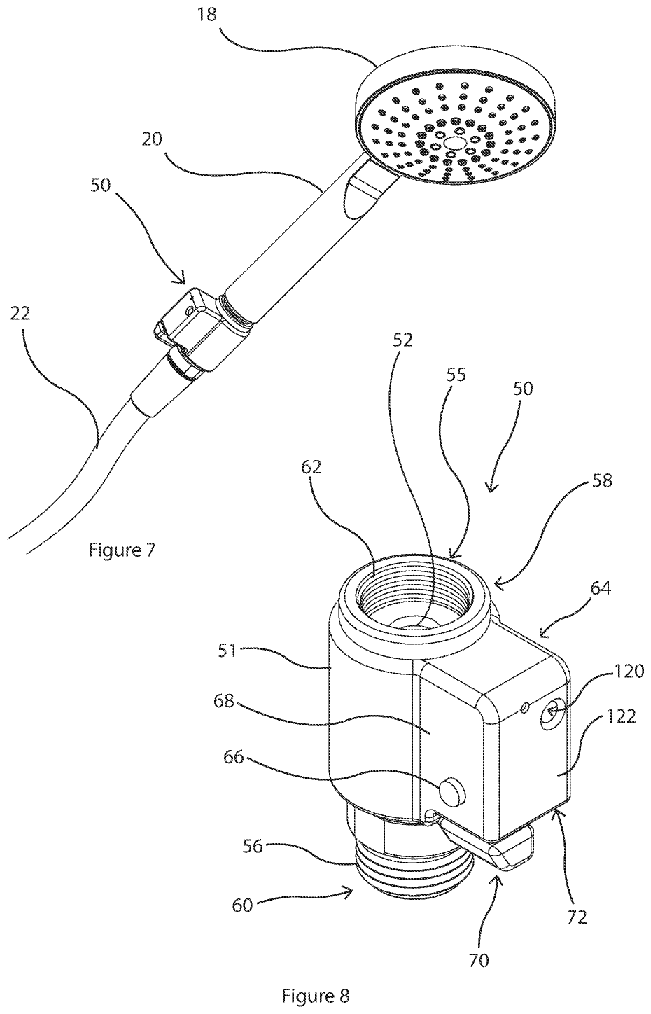

As is described above, an adapter is utilised to releasably secure the shower head 12 to the holder 48 to prevent accidental or unintended removal of the shower head 12 from the holder 48 which may otherwise occur, for example, as the arm 32 or extension member 42 are moved during use. Referring now to FIG. 6A, there is shown a generally tubular adapter 50 according to an exemplary embodiment of the invention. The adapter 50 is threadably connectable at one end to the shower head 12 via a external circumferential thread 54 extending from a proximal end of the tubular conduit 20 of the shower head 12, and is further threadably connectable at an opposite end to the flexible hose 22 via an external circumferential thread 56 extending from a proximal, or lower, end of the adapter 50. FIG. 6A shows an exploded view of the flexible hose 22, adapter 50, and shower head 12, whereas FIG. 7 shows these components threadably connected to one another. As will be appreciated, in FIG. 7, the adapter 50 is mechanically and fluidly connected between the flexible hose 22 and the tubular conduit 20 to thereby enable fluid to flow from the water supply means through the flexible hose 22 and ultimately to the rose 18 of the shower head 12.

In an alternative embodiment, the adapter may be connectable about the tubular conduit 20 of the shower head 12, as opposed to being connected in line between the tubular conduit 20 and the flexible hose 22. An example of this embodiment is illustrated in FIG. 6B. In this embodiment, the adapter 50′ comprises a generally tubular sleeve 51′ adapted to be fitted about the tubular conduit 20 of the shower head 12. Specifically, the tubular sleeve 51′ may comprise a first part-cylindrical portion 51a′ that is hinged relative to a second part-cylindrical portion 51b′ of the tubular sleeve. The first part-cylindrical portion 51a′ may be selectively moveable between an open position and a closed position to thereby secure the tubular sleeve 51′ about the tubular conduit 20 of the shower head 12. The first part-cylindrical portion 51a′ may be fixed in position relative to the second part-cylindrical portion 51b′ by one or more fasteners 53′ that are received through aligned portions of the first part-cylindrical portion 51a′ and the adapter 50′. In this manner, the adapter 50′ may be secured about the shower head 12, as is shown in the drawings of FIG. 6B.

In a further alternative embodiment, the adapter may be integral with the shower head. An example of this embodiment is illustrated in FIG. 6C. In this embodiment, the adapter 50″ is integral with the tubular conduit 20″ of the shower head 12″ and protrudes generally laterally therefrom. The adapter 50″ may be located at any position along the length of the tubular conduit 20″, but is preferably located generally adjacent a distal end of the tubular conduit 20″ near the flexible hose 22″.

As is described below, the adapter may be connectable to the shower head and rotatable about the shower head to allow the adapter to be located on the left side or the right side of the shower head, as desired. An example this arrangement is illustrated in FIG. 6D. In this figure, there is illustrated an adapter 50′″ that may be rotated as desired to locate the protruding portion of the adapter 50″ on either the left side of the right side of the shower head 12 to thereby provide additional flexibility in the location of the shower head in the device 10.

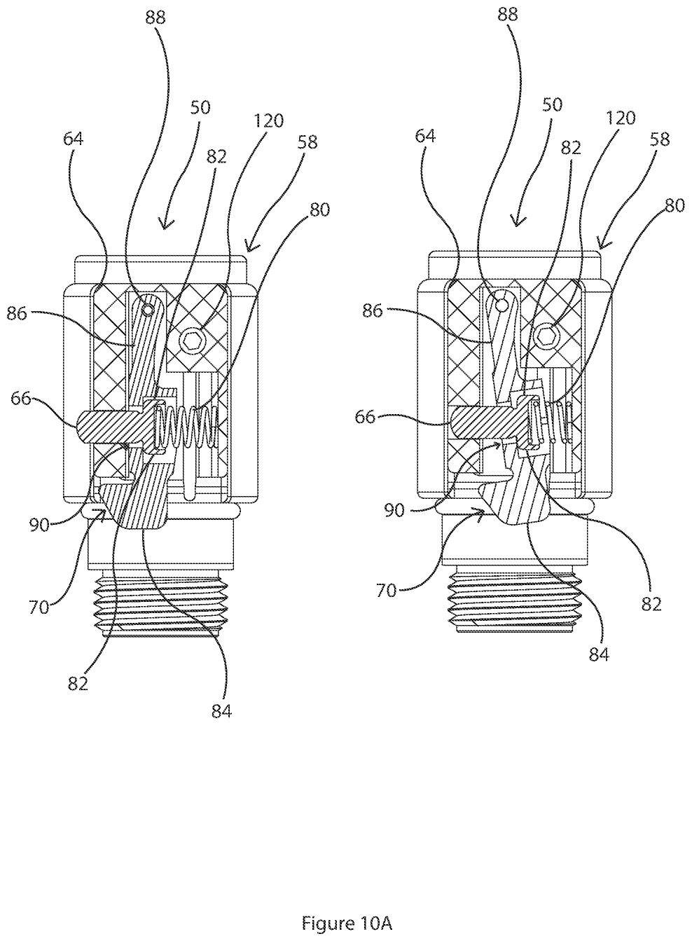

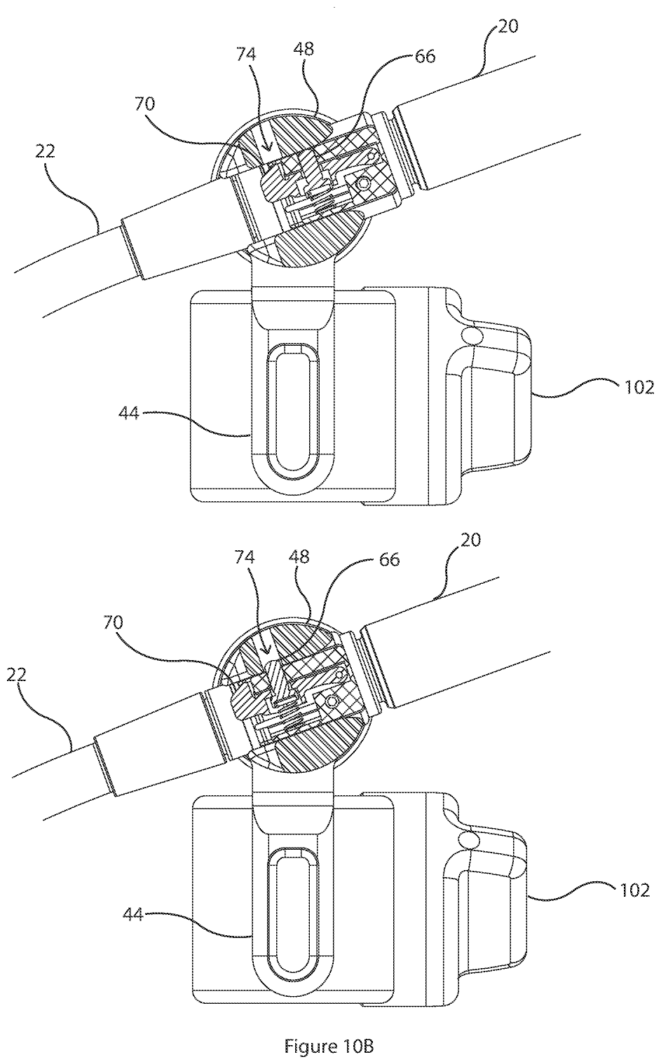

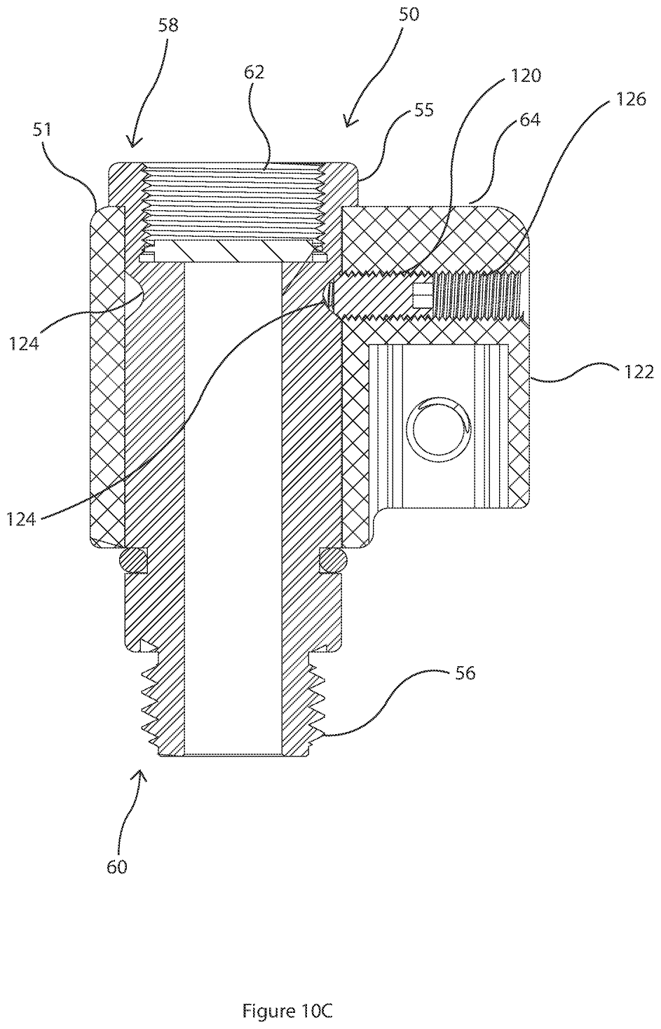

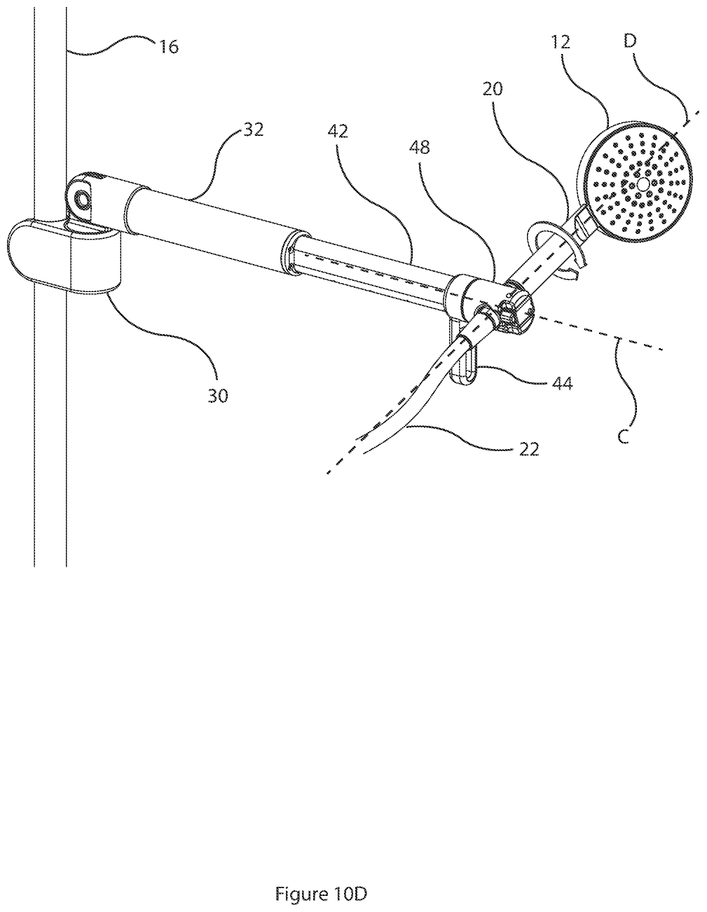

The first embodiment of the adapter 50 illustrated in FIGS. 6, 7, and 8 to 10 will now be described in greater detail. Referring to FIG. 8, the adapter 50 comprises a generally tubular sleeve 51 and a laterally protruding portion 64 that protrudes laterally from the tubular sleeve 51 and which has a generally rectangular cross-section (also see FIG. 10C). The tubular sleeve 51 is adapted to removably receive a tubular element 55 having a bore 52 extending therethrough from an upper end 58 to a lower end 60 thereof to thereby enable fluid to flow through the adapter 50. The tubular element 55 includes an internal circumferential thread 62 at its upper end 58 that is configured to threadably engage the external circumferential thread 54 extending from the proximal end of the tubular conduit 20 to thereby mechanically connect the adapter 50 to the shower head 12. The tubular element 55 further includes the external circumferential thread 56 at its lower end 60, which thread 56 is configured to threadably engage an internal circumferential thread (not shown) extending from a distal end of the flexible hose 22 to thereby mechanically connect the adapter 50 to the flexible hose 22.

As is shown in FIG. 8, the adapter 50 further includes the portion 64 that protrudes laterally from the tubular sleeve 51, and which extends substantially along the entire length of the sleeve 51 from the upper end 58 to the lower end 60 thereof. As described below, the adapter 50 includes locking mechanism which may selectively lock the orientation of the tubular sleeve 51 with respect to the tubular element 55. The protruding portion 64 includes a moveable element in the form of a generally circular pin 66 that extends from a side face 68 of the protruding portion 64 in a direction generally perpendicular to an axial or longitudinal direction of the sleeve 51 of the adapter 50. In the manner described below, the pin 66 is configured to releasably engage within a complimentary circular aperture 74 (FIG. 2) within the holder 48 to thereby secure the adapter 50 (and thus shower head 12) to the device 10. The pin 66 is biased to an extended position (shown in FIG. 8) by a compression spring described later.

As is shown in FIG. 2, the holder 48 is generally U-shaped in side cross-section, and comprises an upper arm portion 76 and a separate lower arm portion 78 that define the generally U-shape. The U-shape is part-circular in cross-section at its lower or proximal end to thereby be complementary to the tubular shape of the sleeve 51 of the adapter 50. The upper arm portion 76 includes the complementary circular aperture 74 on an internal face thereof, which internal face faces the lower arm portion 78. As is described above, the pin 66 is configured to engage within the circular aperture 74 to thereby releasably secure the shower head 12 to the holder 48. As will be appreciated, the upper and lower arm portions 76, 78 of the holder 48 are separated by a distance that corresponds to a width of the protruding portion 64 of the adapter 50 to thereby snuggly engage the side faces of the protruding portion 64 when the adapter 50 (and thus shower head 12) is slidably received within the holder 48.

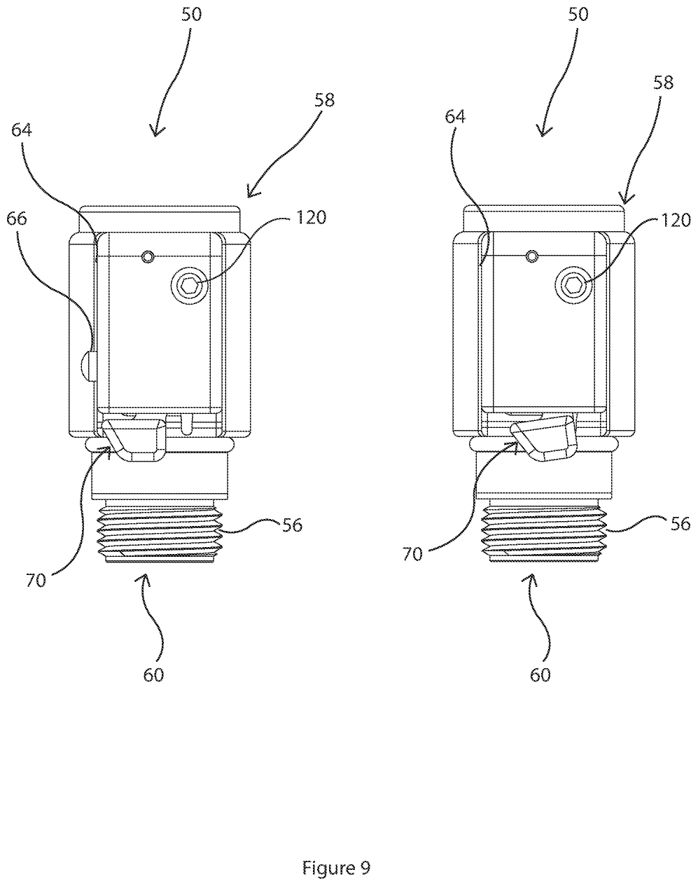

Referring back to FIG. 8, the protruding portion 64 further includes a release means in the form of a pushable or pressable element in the form of a generally trapezoidal button 70 located on a lower face 72 of the protruding portion 64. As is shown in FIG. 8, the lower face 72 is generally perpendicular to the side face 68, and faces the lower end 60 of the adapter 50. Referring now to FIG. 9, it can be seen that the button 70 is movable in a direction generally perpendicular to the axial direction of the adapter 50 (in FIG. 9, from left to right), to thereby move the pin 66 from the extended position (shown in FIG. 8 and in the left-most drawing in FIG. 9) to a retracted position (show in the right-most drawing in FIG. 9). In the retracted position, the pin 66 is located wholly within the protruding portion 64. As will be appreciated, when the pin 66 is in the retracted position, the pin 66 is removed from within the circular aperture 74 located in the holder 48, and thus the adapter 50 (including the connected shower head 12) is removable from its secured position within the holder 48. In other words, the shower head 12 is removable from the holder 48 when the button 70 is pushed or pressed against the bias provided by the compression spring. However, conversely, when the button 70 is in its unactuated position (shown in FIG. 8 and in the left-most drawing in FIG. 9), the pin 66 is in its extended position and is located within the aperture 74 in the holder 48, and thus the shower head 12 is advantageously releasably secured within the holder 48 to prevent unintended or inadvertent removal of the shower head 12 from the holder 48 during use of the device 10.

Referring now to FIG. 10A, two partial cross-sectional views of the adapter 50 are shown. As can be seen in this Figure, there is a compression spring 80 located internally within the protruding portion 64 and oriented in a direction generally perpendicular to the axial direction of the adapter 50. One end of the compression spring 80 is seated within a base 82 of the pin 66, and an opposite end of the compression spring 80 is seated against an internal surface of the protruding portion 64. In this manner, the circular pin 66 is biased to the extended position (shown in the left-most drawing in FIG. 10A) by the spring 80. The button 70 includes a portion 84 that extends outwardly from the protruding portion 64 and which is contactable by a finger to enable the button 70 to be depressed and thereby moved from its unactuated position (shown in the left-most drawing in FIG. 10A) to the actuated position (shown in the right-most drawing in FIG. 10A). The button 70 further includes an elongate portion 86 connected to the contactable portion 84 at one end, and which extends internally within the protruding portion 64 to be pivotally mounted at its opposite end by a pin 88 located generally adjacent the upper end 58 of the adapter 50. As will be appreciated, the button 70 pivots about the pin 88 between the unactuated and actuated positions. As is shown in FIG. 10A, the elongate portion 86 of the button 70 includes an opening 90 dimensioned to receive the circular pin 66 therethrough. The opening 90 is dimensioned such that the edges surrounding the opening 90 contact the base 82 of the pin 66. In this manner, when the contactable portion 84 of the button 70 is depressed to move the button 70 from the unactuated position to the actuated position, the edges surrounding the opening 90 contact the base 82 of the pin 66 to thereby move the pin 66 against the bias of the spring 80 to the retracted position. Conversely, when the button 70 is released, the base 82 of the pin 66 contacts the edges surrounding the opening 90 in the elongate portion 86 of the button 70 to thereby move the button 70 from the actuated position to the unactuated position.

FIG. 10B shows two partial cross-sectional views of the holder 48 and the adapter 50. In this figure, the shower head 12 and connected adapter 50 are being slid relatively within the holder 48 to thereby secure the shower head 12 to the holder 48. In the uppermost drawing in FIG. 10B, it can be seen that the circular pin 66 of the adapter 50 is located relatively within the protruding portion 64 of the adapter 50 as the shower head 12 is being slid into the holder 48. In the lowermost drawing in FIG. 10B, it can be seen that shower head 12 has been slid relatively further into the holder 48 such that the circular pin 66 of the adapter 50 is located in the extended position within the circular aperture 74 of the holder 48. In this manner, the shower head and connected adapter 50 are secured to the holder 48 and cannot be removed therefrom unless the release means 70 is actuated. Accordingly, FIG. 10B illustrates that the pin 66 self-locks on insertion of the shower head 12 and connected adapter 50 into the holder 48.

As described above, the adapter 50 further includes a locking mechanism that is configured to lock the orientation of the tubular sleeve 51 with respect to the tubular element 55 (and thus lock the orientation of the connected shower head 12 with respect to the holder 48 when located within the holder 48). As is described above, the adapter 50 is a one-piece construction comprising the tubular sleeve 51 and the laterally protruding portion 64. The tubular sleeve 51 is adapted to receive the separate tubular element 55 defining the bore 52. The tubular element 55 comprises the inner circumferential thread 62 and the outer circumferential thread 56. As is explained above, the inner circumferential thread 62 is configured to threadably connect to the thread 54 (FIG. 6A) of the shower head, and the outer circumferential thread 56 is configured to threadably connect to the internal thread in the hose 22 to thereby fluidly connect the adapter 50 to the shower head. In this manner, fluid may flow through the hose 22, and then through the bore 52 of the tubular element 55 (and thus through the adapter 50) to the shower head 12.

In order to lock the rotational orientation of the tubular element 55 with respect to the tubular sleeve 51 of the adapter 50, the protruding portion 64 includes a locking mechanism in the form of a threaded element that extends at least partially through the protruding portion 64 to contact a portion of the tubular element 55. In the embodiment illustrated in FIG. 10C, the locking mechanism is in the form of a threaded grub screw 120 which extends through the protruding portion 64 from an outer face 122 thereof to be located within a shallow circumferential channel 124 located about the tubular element 55. As shown in FIG. 10C, the shallow circumferential channel 124 has a generally semi-circular cross-section and is located relatively closer to the upper end 58 of the adapter 50 compared to the lower end 60.

As will be appreciated, the threaded grub screw 120 is threadably movable along threads 126 within the protruding portion 64 between a non-locking position and a locking position. In the position illustrated in FIG. 10C, the grub screw 120 is in the locking position and acts to rotationally lock the tubular sleeve 51 and protruding portion 64 relative to the tubular element 55 by contacting the tubular element 55 and being located within the circumferential channel 124. The grub screw 120 may be moved to a non-locking position (not shown) by rotating the grub screw 120 along the threads 126 such that the grub screw 120 is in a retracted non-contacting position relative to the circumferential channel 124 in the tubular element 55. An appropriate tool may be used to rotate the grub screw 120 to move the grub screw 120 in a manner known to those skilled in the art.

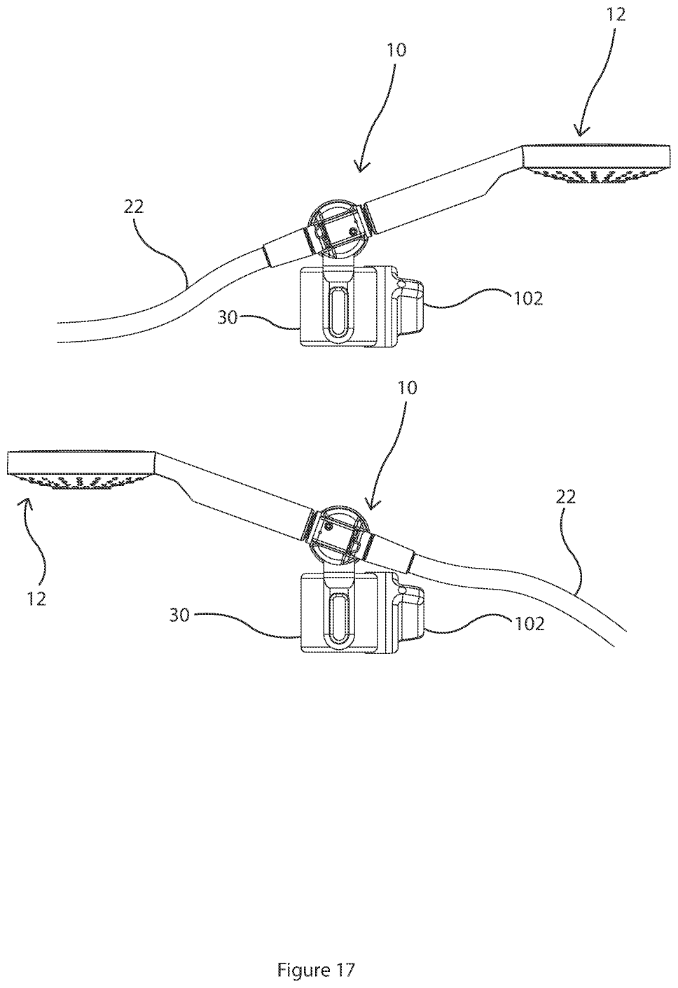

As is shown in FIG. 10D for example, the outer face 122 of the protruding portion 64 of the adapter 50 faces relatively away from the holder 48 when the adapter 50 (and connected shower head 12) are located within the holder 48. In this manner, the grub screw 120 is located in a convenient position that allows for the grub screw 120 be adjusted whilst the shower head 12 and connected adapter 50 are secured within the holder 48. In this manner, the grub screw 120 may be moved to the non-locking position to allow for rotation of the shower head 12 about an axis D that extends generally parallel to a longitudinal axis of the tubular conduit 20 of the shower head 12. As is shown in FIG. 10D, the axis D is generally perpendicular to the axis C that extends generally parallel to the longitudinal axis of the extension member 42. Accordingly, as the rotational position of the tubular sleeve 51 relative to the tubular element 55 is adjustable by the grub screw 120, the shower head 12 may be mounted to face either left or right of the arm 32 as illustrated in FIG. 17.

Accordingly, the device 10 is advantageously adjustable about each of the axes A to D as is shown in FIG. 5A for example, to allow for precise placement of the shower head 12 relative to the user. Specifically, the arm 32 may be rotated about each of the perpendicular axes A and B, the holder 48 may be rotated about the axis C, which is perpendicular to each of the axes A and B, and the shower head 12 may be rotated about the axis D, which is perpendicular to the axis C. Furthermore, the extension member 42 is translatable relative to the arm 32.

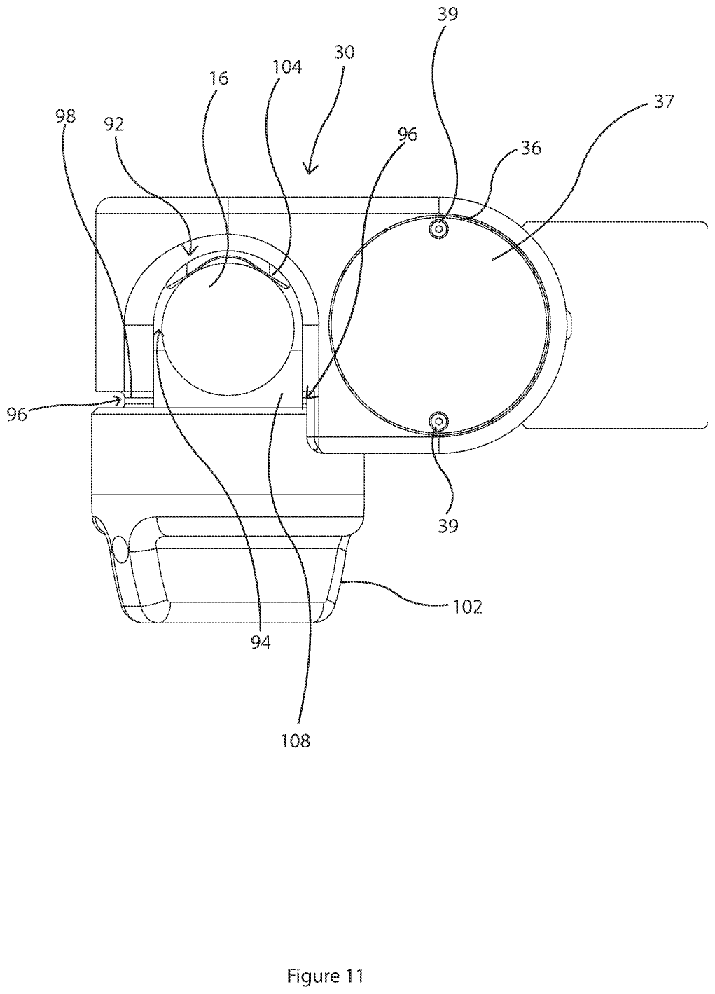

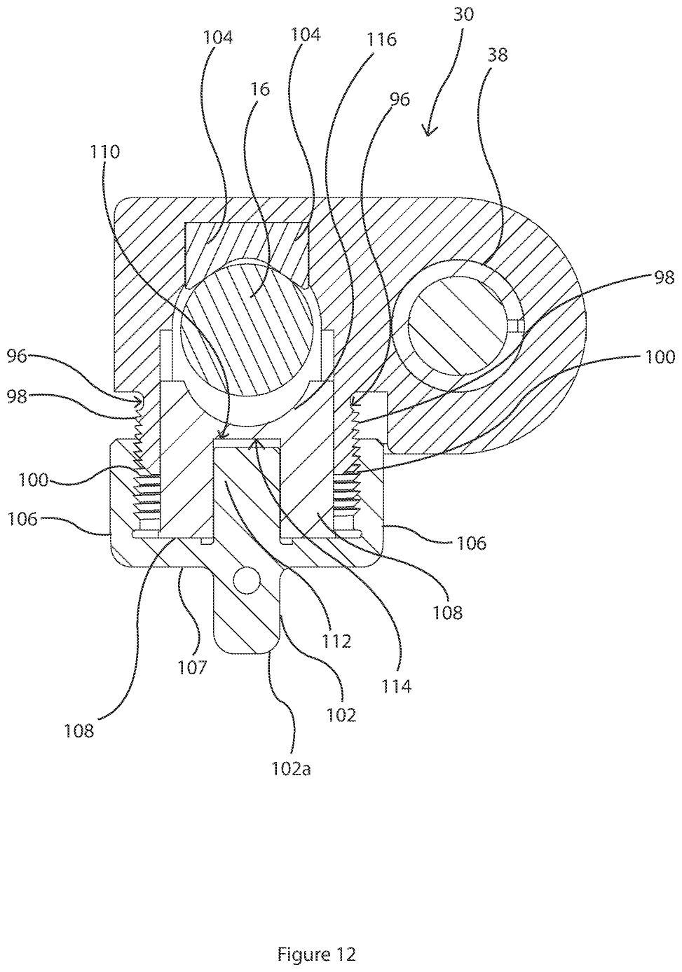

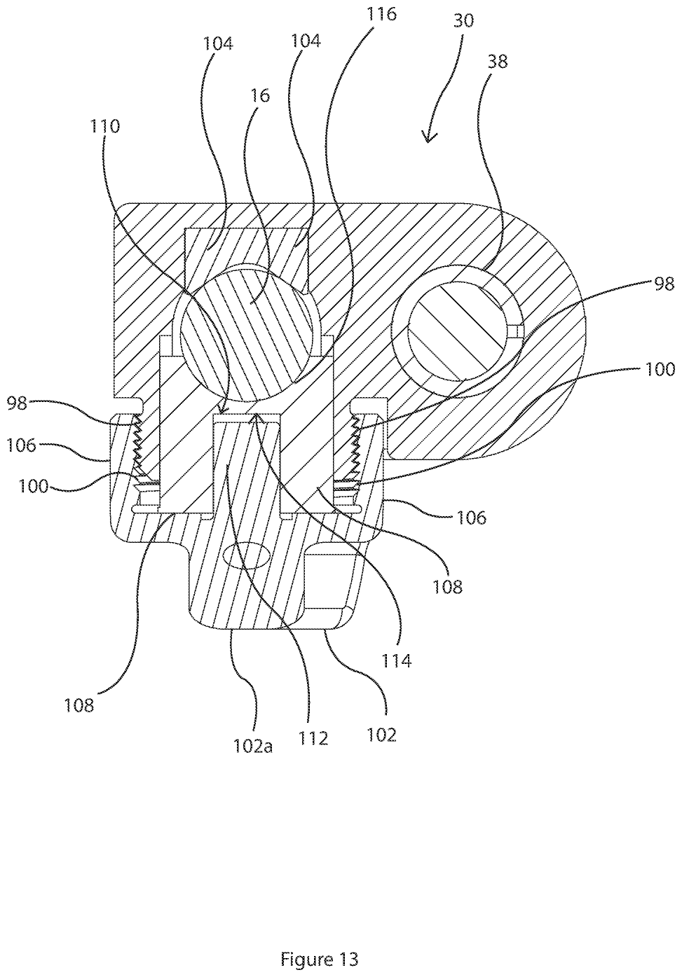

The manner in which the device 10 is mounted to the tubular rail 16 (FIG. 1) will now be described with reference to FIGS. 11 to 13. Referring initially to FIG. 11, it can be seen that base 30 includes a mounting portion 92 at a proximal end of the base 30 generally adjacent to the circular bore 36 that receives the tubular bearing 38 (FIG. 12) of the arm 32. In FIG. 11, the tubular bearing 38 is located under a generally circular cover plate 37 that is fixed in place by a pair of fasteners 39. The mounting portion 92 comprises a generally U-shaped opening 94 within the base 30. The U-shaped opening 94 is defined by a pair of part-circular arms 96 that protrude laterally from the base 30, and which include circumferential threads 98 on an outer surface thereof that are configured to be threadingly connected to an inner circumferential thread 100 (FIG. 12) located within a knob 102. As will be appreciated, the U-shaped opening 94 allows the base 30 to be slidably received about the tubular rail 16. Specifically, when mounting the base 32 to the rail 16, the base 30 is moved relative to the rail 16 such that the rail 16 is received within the U-shaped opening 94 defined by arms 96 to be located against a generally resilient cushioning member 104. The resilient cushioning member 104 is located against the curved closed end of the U-shaped opening 94, and is dimensioned to snuggly engage the outer curved surface of the tubular rail 16.

Referring now to FIG. 12, it can be seen that the knob 102 has a substantially cylindrical section 106 that extends from a top portion 107 of the knob 102. The top portion 107 defines a protrusion 102a that may be grasped between the user's fingers to assist with rotating the knob 102. The cylindrical section 106 includes the inner circumferential thread 100 along an inner surface thereof, which thread 100 is configured to threadingly engage the outer circumferential threads 98 on the part-circular arms 96 of the mounting portion 92 to thereby connect the knob 102 to the mounting portion 92. Furthermore, the cylindrical section 106 of the knob 102 define a generally circular opening within the knob 102 which is dimensioned to contact and move a further resilient element 108 to thereby adjustably close the space defined by the U-shaped opening 94. The resilient element 108 is generally circular in cross-section and includes a recess 110 in one end thereof that is configured to be engaged by a protrusion 112 that extends from an inside surface of the knob 102 in the same direction as the arms 106 of the knob 102. The recess 110 acts as an alignment feature for the protrusion 112 (and thus the knob 102) to ensure that the knob 102 is correctly threaded about the outer circumferential threads 98 of the part-circular arms 96.

As is shown in FIG. 12, the protrusion 112 appears generally rectangular in cross-section and extends from a generally central position within the knob 102. The protrusion 112 is configured to contact an internal wall 114 of the recess 110 of the resilient element 108 as the knob 102 is rotated. Upon initial insertion, the protrusion 112 contacts the recess 110 to assist with aligning the knob thread 100 with the threads 98 on the part-circular arms 96 of the mounting portion 92. As the knob 102 is rotated in a clockwise direction, an inside surface of the top portion 107 of the knob 102 contacts and pushes the resilient element 108 toward the U-shaped opening 94 to thereby close the space defined by the U-shaped opening. This movement of the resilient element 108 is shown when comparing the relative positions of the resilient element 108 in FIGS. 11 and 12. As shown in these Figures, the resilient element 108 further includes a part-circular end 116 opposite the end containing the recess 110. Advantageously, the part-circular end 116 is dimensioned to snuggly engage the outer curved surface of the tubular rail 16 (as is shown in FIG. 12) as the knob 102 is rotated. In this manner, the base 30 may be secured about the tubular rail 16. As will be appreciated, the base 30 may be removed from about the rail 16 by rotating the knob 102 in a counterclockwise direction such that the knob 102 is removed entirely from engagement with the arms 96 of the mounting portion 92. The resilient element 108 can then be removed from the U-shaped opening 94, and the tubular rail 16 can thus be slidably removed from U-shaped opening 94. The resilient element 108 may comprise a rubber material.

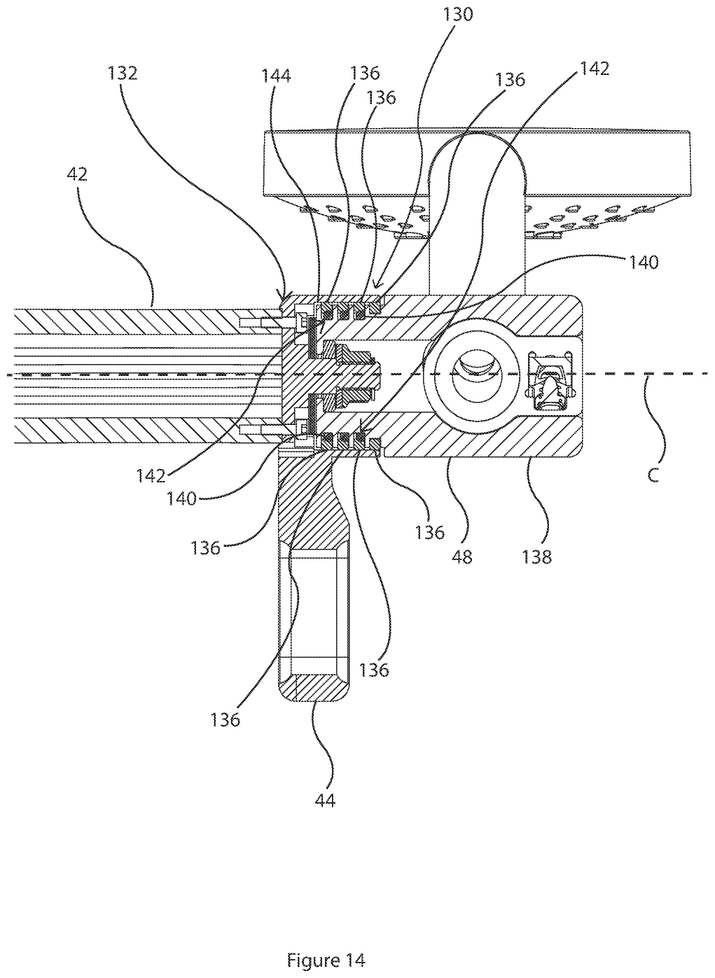

FIGS. 14 to 16 illustrates respective retarding mechanisms that act to retard the movement of the device 10 about its axes of motion. The retarding mechanisms are specifically configured to slow or dampen the movement of the device. Advantageously, in this way, one or more of the retarding mechanisms of the device 10 may provide resistance to movement of the arm 32 if the arm 32 is inadvertently moved, such as by being bumped accidentally. If the arm 32 is bumped accidentally, one or more of the retarding mechanisms will act to resist the movement of the arm 32 and thereby reduce the risk that the arm 32 may injure the user or any other person.

Referring initially to FIG. 14, there is shown a retarding mechanism 130 located about a distal end 132 of the holder 48. The retarding mechanism 130 acts to retard rotational movement of the holder 48 about axis C relative to the distal end 134 of the extension member 42. The retarding mechanism 130 comprises a first element in the form of a plurality of rings 136 located about the distal end 132 of the holder 48. In the illustrated embodiment, the retarding mechanism 130 includes four such rings 136. Each of the rings 136 are at least partially located within respective circumferential channels 142 extending about the outer surface 138 of the distal end 132 of the holder 48. Each of the rings 136 include respective lateral protrusions (not shown) that are located within respective complementary recesses (not shown) in the outer surface 138 of the distal end 132 of the holder 48. The recesses extend partially circumferentially about the outer surface 138 and extend partially along the outer surface 138 in a longitudinal direction. As the lateral protrusions are located within the respective recesses, each of the rings 136 is rotationally and translationally locked relative to the holder 48.

As is shown in FIG. 14, a distalmost three of the rings 136 interface with a second element in the form of respective O-rings 140. The O-rings 140 are dimensioned to be located in the respective circumferential channels 142 that extend about the outer surface 138 of the holder 48. As is shown in the figure, the O-rings 140 are located in the respective circumferential channels 142 so as to contact a base of the channel on one side thereof, and contact a portion of a respective ring 136 on an opposite side thereof. Each of the O-rings 140 thus contact a portion of a respective ring 136 and thereby cause an outer surface of each of the rings 136 to contact an inner circumferential portion 144 of the device 10 at the distal end of the extension member 42. In essence, by contacting the inner circumferential portion 144, the rings 136 create friction between the holder 48 and the circumferential portion 144, which thereby acts to retard or slow rotational movement of the holder 48 with respect to the extension member 42.

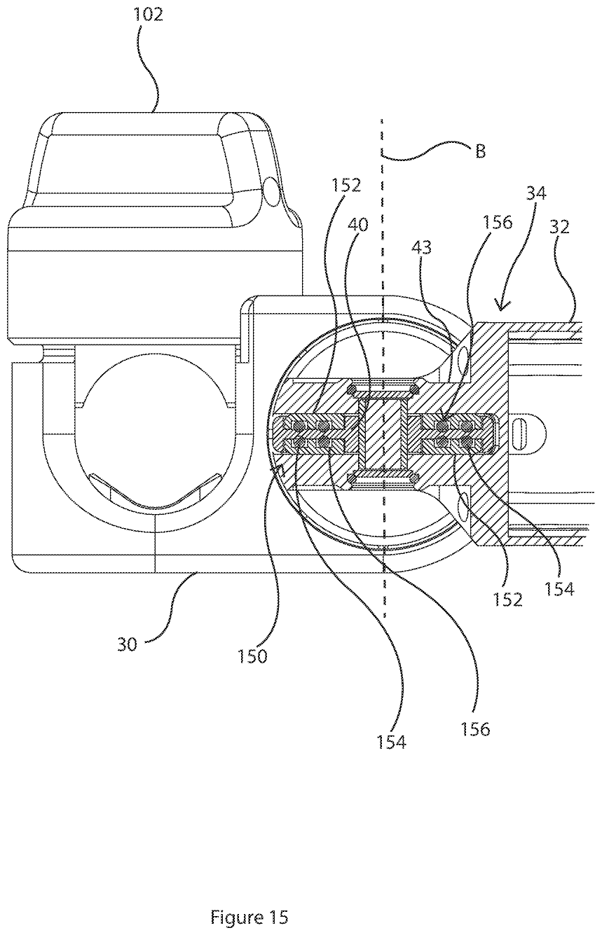

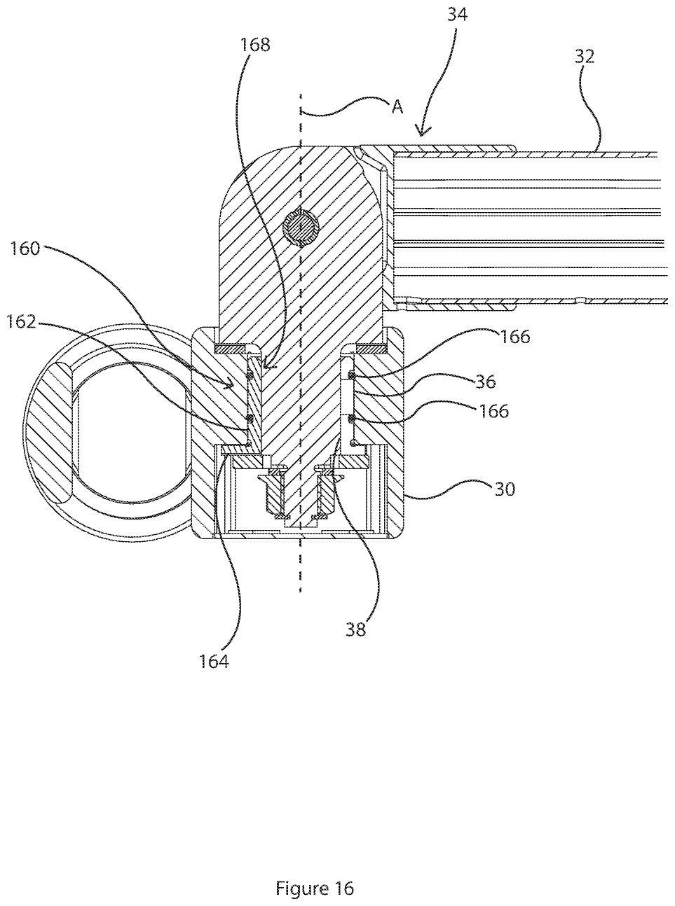

Referring now to FIG. 15, there is shown a partial top-down cross-sectional view of the base 30 and the proximal end 34 of the arm 32. The proximal end 34 of the arm 32 also includes a retarding mechanism 150. The retarding mechanism 150 is similar in operation to the retarding mechanism 130 and comprises a first element in the form of two generally circular rings 152. The two generally circular rings 152 include radial protrusions (not shown) that are located in respective complimentary recesses in the plate-like member 40 (also see FIG. 3) that extends upwardly from the base 30. In this manner, the circular rings 152 are rotationally and translationally locked relative to the plate-like member 40. The retarding mechanism 150 also includes a second element in the form of four O-rings 154. Each circular ring 152 includes a pair of concentric circular channels 156 in a face thereof adapted to receive a respective O-ring 154. As is shown in FIG. 15, the circular rings 152 are oriented about the plate-like member 40 such that the openings of the concentric circular channels 156 face the plate-like member 40. Accordingly, the O-rings 154 are located to contact the plate-like member 40 on one side thereof and to contact the circular channels 156 of the circular rings 152 on an opposite side thereof. In the same manner as described above in relation to the retarding mechanism 130, the O-rings 154 act to cause an outer surface of each of the circular rings 152 to contact the forked end section 43 of the arm 32. Thus, friction is created as the arm 32 is pitched relative to the base 30 about the axis B by the outer surface of the circular rings 152 contacting the forked end section 43 of the arm 32. This friction acts to slow or retard the movement of the arm 32 about the axis B. FIG. 16 illustrates another retarding mechanism 160 located in the base 30 of the device 10. Similar to the above, the retarding mechanism 160 acts to retard movement of the arm 32 relative to the base 30. Specifically, the retarding mechanism 160 acts to retard rotational movement of the arm 32 about the axis A. The retarding mechanism 160 comprises first element in the form of a split bushing 162 that is located about the tubular bearing 38 within the base 30. The bushing 162 includes a lateral protrusion 164 at a lower end thereof that is located within a complimentary recess in the base 30 to thereby prevent rotational and translational movement of the bushing 162 relative to the tubular bearing 38. The retarding mechanism 160 also comprises a second element in the form of a pair of O-rings 166. The O-rings 166 are located spaced apart along the length of the bushing 162 within respective circumferential recesses 164 in an outer surface of the bushing 162. The O-rings 166 contact an inner generally circular side wall of the base 30 on one side thereof, and contact the bushing 162 generally on an opposite side thereof. Similar to the above, the O-rings 166 act to cause an inner surface 168 of the bushing 162 to contact the tubular bearing 38 to thereby create friction between the bushing 162 and the bearing 38 as the bearing 38 is rotated by rotation of the arm 32. Thus, the friction caused by the bushing 162 acts to slow or retard the movement of the arm 32 about the axis A.

Advantageously, as is described above, each of the retarding mechanisms 130, 150, and 160 act to retard, slow, or dampen the movement of the holder 48 and arm 32 about their respective axes of movement and may therefore assist in reducing the risk that inadvertent movement of the device will cause injury to the user or any other person.

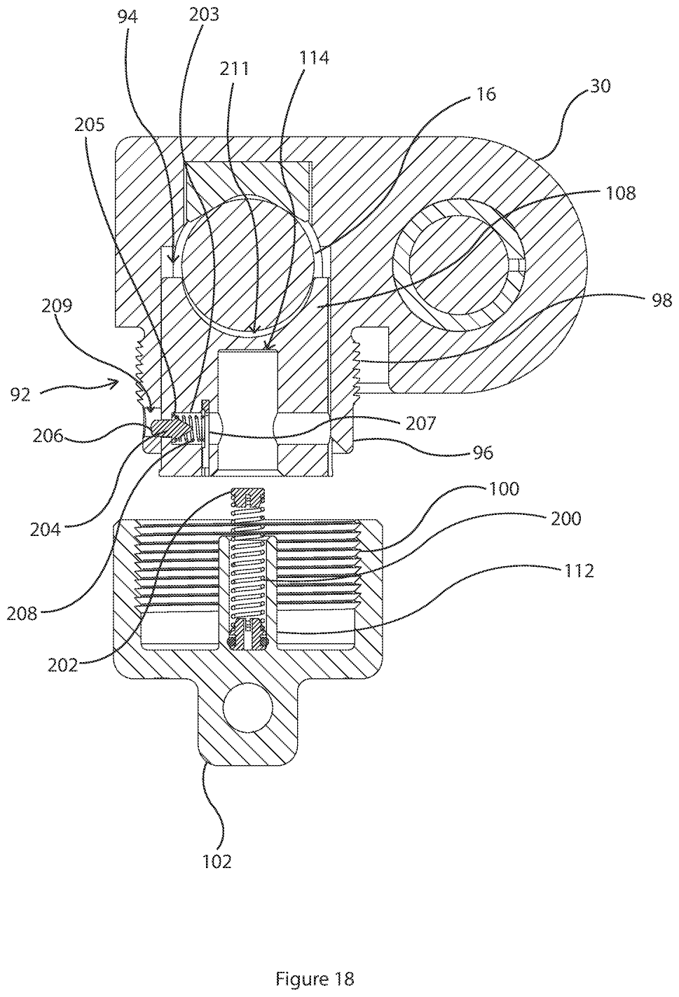

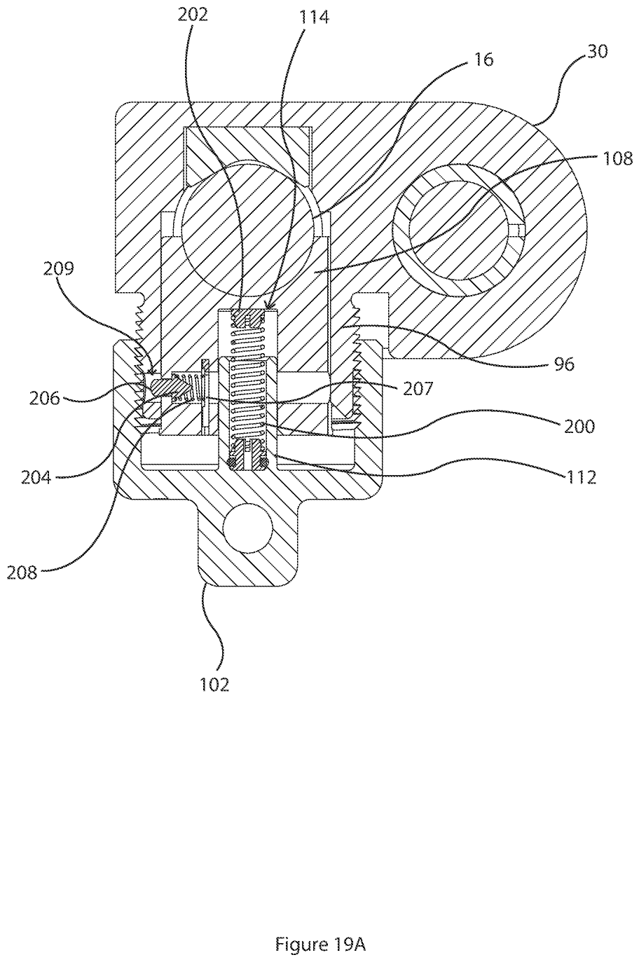

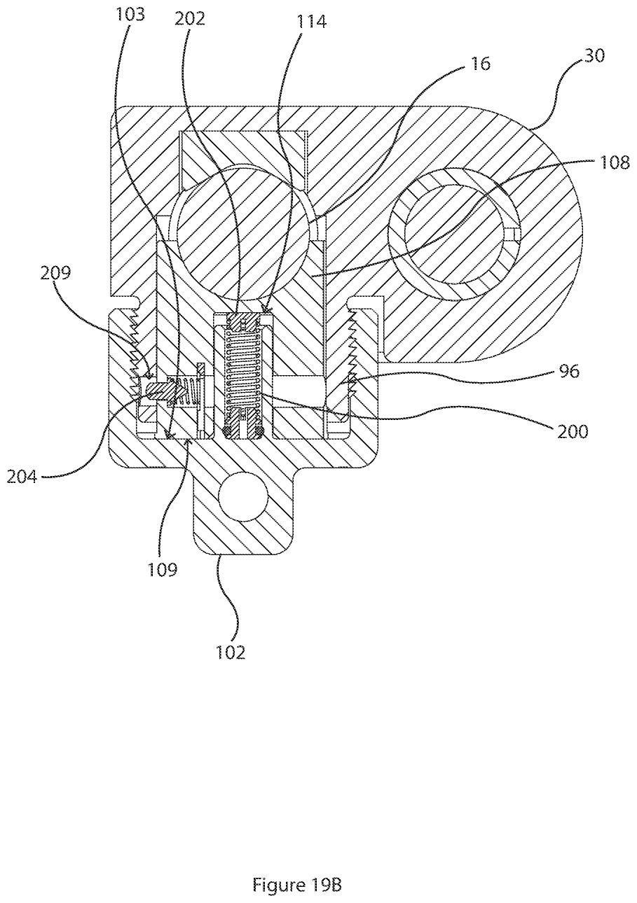

FIGS. 18 to 19B illustrate an alternative embodiment of the knob 102 and an alternative embodiment of the resilient element 108 that is located generally within the mounting portion 92 (of the base 30). In this embodiment, the resilient element 108 and the knob 102 are substantially as described above, but the knob 102 includes a biasing element configured to bias the resilient element 108 into a contacting position with the rail 16, and the resilient element 108 includes a safety element that is configured to interface with at least one of the part-circular arms 96 of the mounting portion 92 to thereby prevent withdrawal of the resilient element 108 from the opening 94 defined by the part-circular arms 96 of the mounting portion 92 (if the knob 102 were fully removed from its threaded engagement with the arms 96, for example).

Referring initially to FIG. 18, it can be seen that the central protrusion 112 of the knob 102 defines a cylindrical bore that at least partially houses a biasing element in the form of a cylindrical compression spring 200. The compression spring 200 includes, at an outer end thereof, a pin-like element 202 having a generally circular cross-section. The pin-like element 202 is biased to an extended position (illustrated in FIG. 18) by the compression spring 200. Accordingly, the pin-like element 202 is configured to contact and engage the internal wall 114 of the resilient element 108 when the knob 102 is at least partially threadably connected to the part-circular arms 96 of the mounting portion 92. In this manner, the pin-like element 202 acts to push the resilient element 108 relatively toward the rail 16 such that the resilient element 108 is always in abutting contact with the rail 16 regardless of the position of the knob 102 on the part-circular arms 96 (as illustrated in FIG. 19A for example). Advantageously, the pin-like element 202 ensures that, when the knob 102 is rotated counterclockwise to thereby remove the knob 102 from threaded engagement with the part-circular arms 96, the resilient element 108 maintains at least partial contact with the rail 16. This consistent at least partial contact of the resilient element 108 against the rail 16 retards the downward movement of the device 10 along the rail 16 as the knob 102 is untightened, and thereby may prevent injury resulting from the device 10 moving along the rail unexpectedly and contacting a person. Additionally, the consistent at least partial contact of the resilient element 108 against the rail 16 allows the device 10 to be safely repositioned along the rail 16.

As is also illustrated in FIGS. 18 and 19, the resilient element 108 includes a pin 204 that is configured to extend from an outer side surface of the resilient element 108. The pin 204 is at least partially located within a generally cylindrical channel 203 that extends partly through the resilient element 108. The pin 204 is biased to an extended position (shown in FIGS. 18 to 19B) by a cylindrical compression spring 208 located within the generally cylindrical channel 203. The cylindrical compression spring 208 engages an inner flanged head 205 of the pin 204 at one end thereof, and is seated against a generally rectangular plate 207 located at an inner end of the generally cylindrical channel 203. In the extended position, the pin 204 protrudes from the outer side surface of the resilient element 108 so as to be located within a generally circular bore 209 extending through the outermost arm 96 (the left-most arm in FIGS. 18 and 19). Accordingly, due to abutting engagement of a side surface of the pin 204 against an inner surface of the bore 209, the resilient element 108 is prevented from being withdrawn from the opening 94 defined by the part-circular arms 96. Specifically, the resilient element 108 is prevented from being withdrawn laterally from the mounting portion 92 in a direction away from the rail 16. However, if desired, the resilient element 108 can be withdrawn from the mounting portion 92 by depressing an outer part-spherical head 206 of the pin 204 to thereby move the pin 204 against the bias of the spring 208. Depressing the pin 204 moves the pin 204 relatively inwardly and thus removes the pin 204 from abutting engagement within the bore 209 located in the outermost arm 96. After depressing the pin 204, the resilient element 108 may be slid relatively outwardly from the mounting portion in order to remove the resilient element 108. Accordingly, the pin 204 acts as a safety element that is configured to prevent unintended withdrawal of the resilient element 108 from the mounting portion 92. Although FIGS. 18 and 19 only illustrate a single pin 204, it will be appreciated that the resilient element 108 may include at least one other pin 204 that may be located on opposite side of the resilient element 108.

As is shown in FIG. 18, when the knob 102 is completely removed from the mounting portion 92, the resilient element 108 is located in an outermost position, but is still secured within the space 94 due to engagement of the pin 204 within the bore 209. Advantageously, in this outermost position, a space 211 is created between the resilient element 108 and the rail 16 to thereby readily allow the base 30 to be moved along the rail 16 to a desired position, but prevents the device 10 from being completely disconnected or removed from the rail 16. As is shown in FIG. 19B, when the knob 102 is fully tightened about the part-circular arms 96, an outermost end face 109 of the resilient element 108 contacts an inner face 103 of the knob 102. Thus, in this position, the resilient element 108 is securely clamped between the knob 102 and the rail 16, and the base 30 (and thus device 10) are thereby secured to the rail 16.

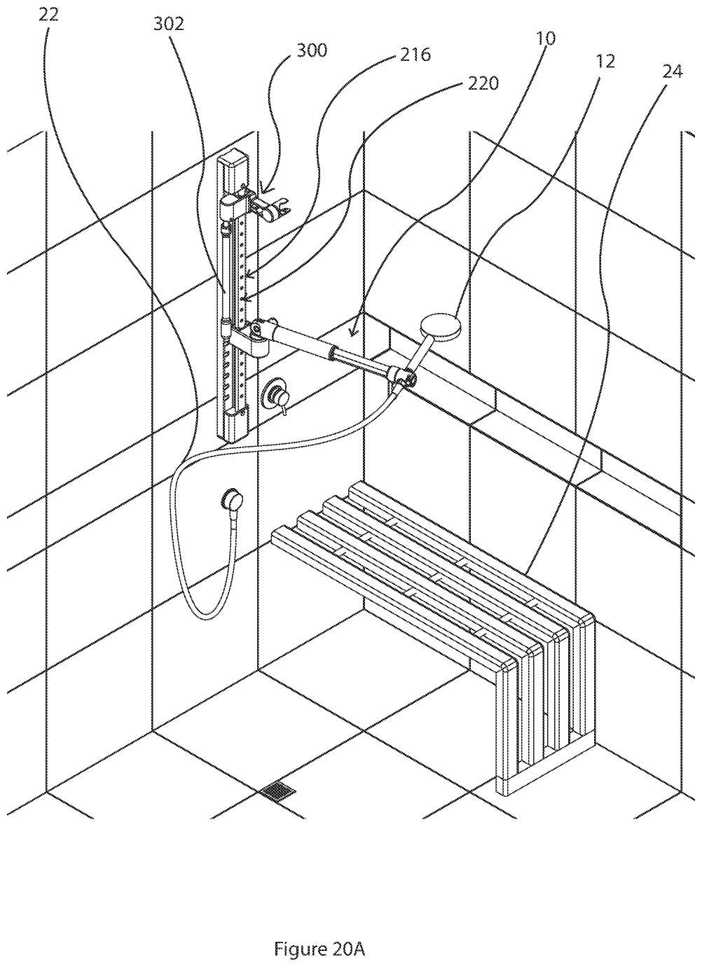

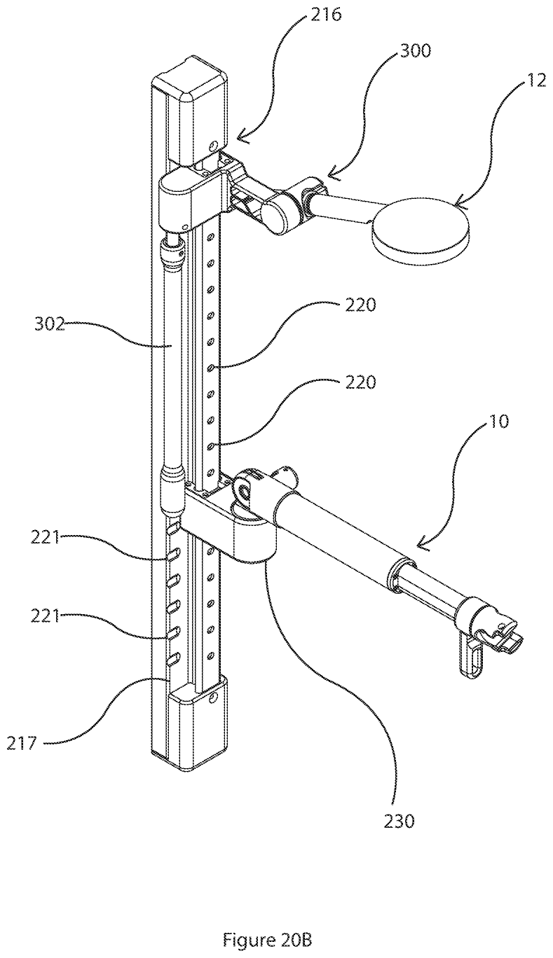

FIGS. 20A and 20B illustrate an alternative embodiment of a rail that may be used in conjunction with the shower head holder device of the present invention. Referring to FIG. 20A, the rail 216 includes a plurality of aligned spaced-apart generally circular mounting apertures 220 that are configured to interface with the device 10 in order to adjustably mount and position the device 10 with respect to the rail 216. In order interface with the rail 216, the device 10 includes an alternative or modified base 230, as detailed below.

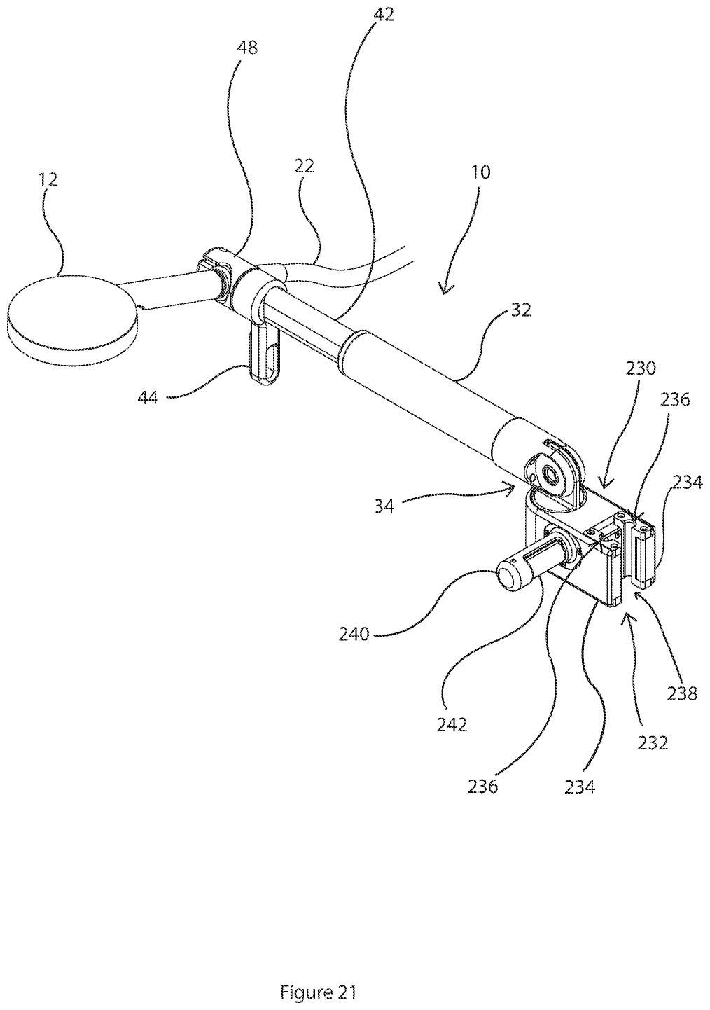

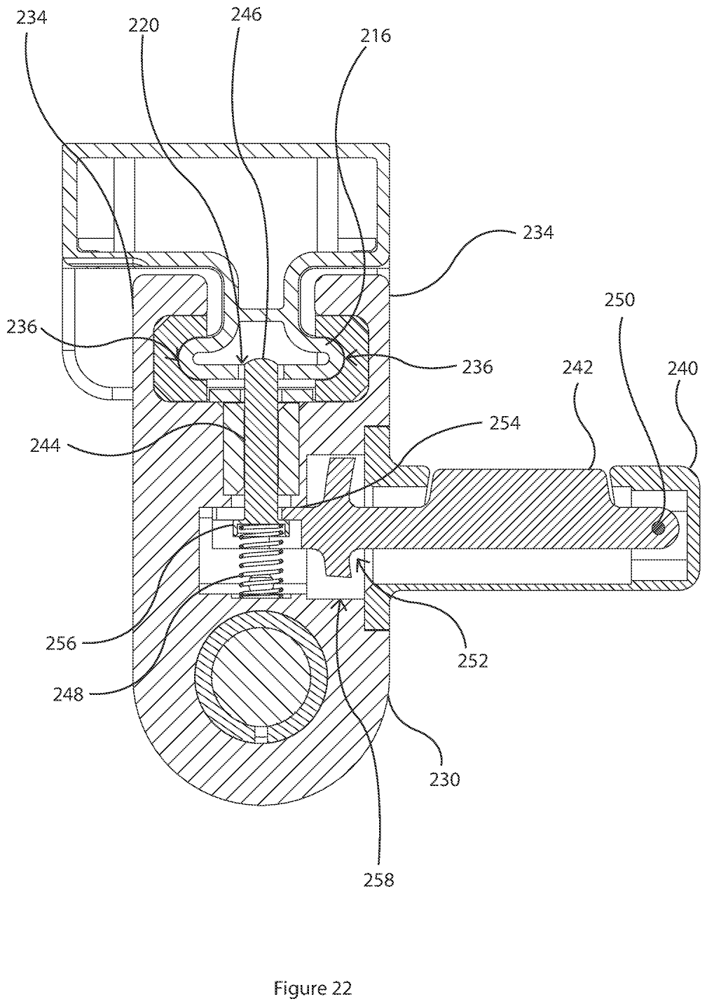

Referring to FIG. 21, the base 230 includes a forked end 232, which end 232 is opposite to the end of the base 230 that is connected to the proximal end 34 of the arm 32. The forked end 232 includes a pair of spaced-apart arms 234 that define the fork-like shape of the forked end 232 of the base 230. The arms 234 are similar in shape and dimension and include respective recesses 236 that are generally semi-circular in cross-section and which extend along respective inner surfaces of the arms 236 from a top-side through to a bottom (or underside) thereof. In this manner, the recesses 236 are aligned with the height direction of the arms 234 (and thus are arranged generally perpendicular to a length direction of the arms 234). Together, the recesses 236 define a generally rectangular channel 238 with curved outer ends (the curved outer ends corresponding to the semi-circular cross-sectional shape of the recesses 236). The generally rectangular channel 238 is dimensioned to fit snugly about the rail 216. The manner in which the base 230 is mounted to the rail 216 is illustrated in the cross-sectional view shown in FIG. 22. As is shown in this figure, the rail 216 fits snugly within the generally rectangular channel 238 defined by the arms 234 of the forked end of the base 230. In particular, the dimensions of the generally semi-circular recesses 236 are complimentary to the curved outer sides of the rail 216.

Referring back to FIG. 21, it can be seen that the base 230 also includes a generally cylindrical actuator 240 that protrudes laterally from the base 230. The cylindrical actuator 240 extends approximately from a transverse and longitudinal centrepoint of the base 230, and includes a part-cylindrical push-button 242 that may be selectively actuated to move the base 230 (and thus the device 10) along the rail 216 in the manner detailed below. As is illustrated in FIG. 21, the cylindrical actuator 240 is generally dimensioned to fit snugly in a person's hand.

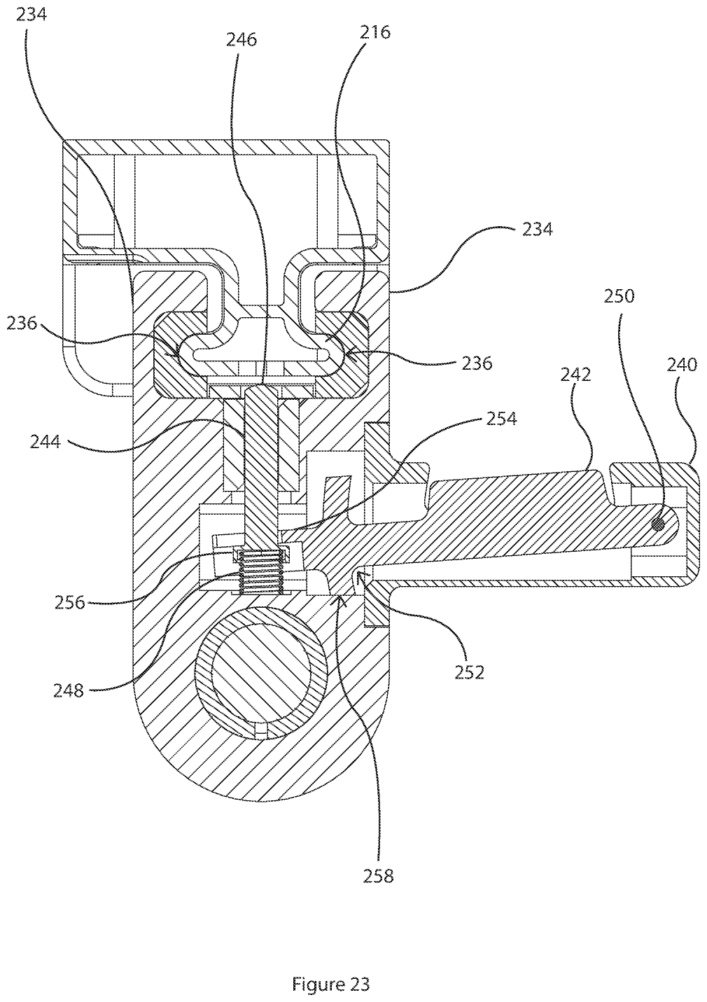

Referring again to the cross-sectional view in FIG. 22, it can be seen that the base 230 includes an elongate pin 244 aligned with the longitudinal direction of the base 230 and located approximately centrally within the base 230. An outer part-spherical end 246 of the pin 244 extends at least partially within the space defined between the forked arms 234 of the base 230, and is configured to move between an extended position (shown in FIG. 22), and a retracted position (shown in FIG. 23). The pin 244 is biased to the extended position by a cylindrical compression spring 248 that is located at, and contacts, a proximal end of the pin 244 (the proximal end being opposite the outer part-spherical end 246). As shown in FIG. 22, in the extended position, the pin 244 is configured to be engaged within one of the aligned spaced-apart generally circular mounting apertures 220 that are arranged along the rail 216. As will be appreciated, when in this position, the pin 244 acts to lock the position of the base 230 (and thus the device 10) with respect to the rail 216.

The pin 244 may be selectively moved, as desired, to its retracted position (shown in FIG. 23) by selectively actuating the part-cylindrical push-button 242. As will be appreciated, when the pin 244 is in the retracted position, the base 230 may be moved relatively upwardly and downwardly along the rail 216 to thereby set a desired position of the device 10 with respect to the rail 216. As is shown in FIGS. 22 and 23, the part-cylindrical push-button 242 is pivotally mounted within the cylindrical actuator 240 about a pivot pin 250 located generally at the outer, or distal end, of the cylindrical actuator 240. The push-button 242 is generally elongate in overall form and extends longitudinally within the cylindrical actuator 242 and at least partially within the base 230. In particular, the push-button 242 comprises an approximately T-shaped inner end 252 located within the base 230. The T-shaped end 252 of the push-button 242 includes a longitudinally-directed extension 254 that contacts a flanged head end 256 of the pin 244 to thereby move the pin 244 in the manner described below.

As is shown by comparing FIGS. 22 and 23, as the push-button 242 is depressed relatively inwardly, the push-button 242 pivots about the pivot pin 250 such that the longitudinally-directed extension 254 of the push-button 242 contacts the flanged head end 256 of the pin 244 to thereby move the pin 244, against the bias of the compression spring 248, from the extended position (FIG. 22) to the retracted position (FIG. 23). As is described above, once the pin 244 is in the retracted position, the part-spherical end 246 of the pin 244 is removed from its engagement within one of the spaced-apart generally circular apertures 220 of the rail 216 so that the position of the device 10 along the rail 216 may be adjusted. As the push-button 242 is depressed relatively inwardly, one lateral side of the T-shaped end 252 of the push-button 242 contacts an internal wall 258 of the base 230 to thereby prevent further inward movement of the push-button 242 (as is illustrated in FIG. 23). In this manner, the internal wall 258 acts as a depth stop for the push-button 242. Once the inwardly directed pushing force on the push-button 242 is released, the bias of the compression spring 248 acts to return the pin 244 to its extended position (FIG. 22), and additionally return the push-button to its resting or unactuated position (FIG. 22).

As is shown in FIGS. 20A and 20B, the system may include in addition to base 230, another shower head holding device 300 spaced apart from the base 320. In this manner, the rail 216 includes two separate shower head holding devices 10, 300 spaced along the rail 216. As will be appreciated, this arrangement allows for a variety of different positions of the shower head 12 relative to the user. For example, with reference to FIG. 20A, the lower shower head holder device 10 could be used to hold the shower head 12 if the user is situated upon the bench 24, and the upper shower head holder device 300 could be used to hold the shower head 12 if the user was standing. The invention extends to a system including an upper and a lower shower head holder device, preferably both located on a common rail.

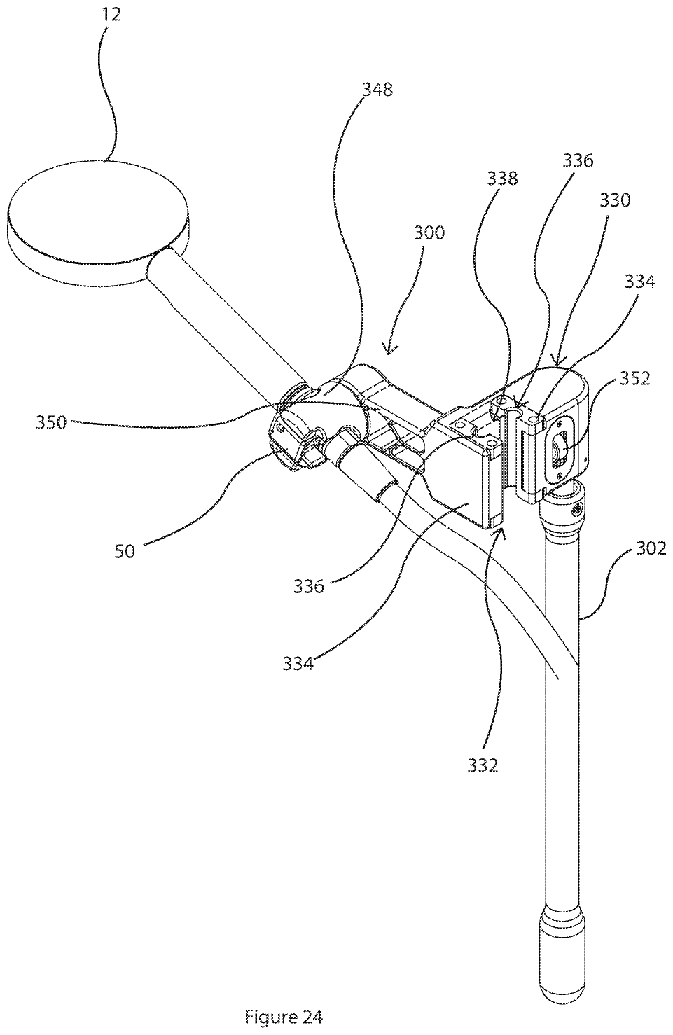

Referring to FIG. 24, the shower head holder device 300 includes a base 330 that is similar to the base 230 in that it includes a forked section 332 defined by spaced-apart arms 334. The arms 334 include generally semi-circular recesses 336 extending along inner surfaces of the arms 334 to define a generally rectangular channel 338 adapted to engage the rail 216 in the same manner as described above with respect to the base 230. The base 330 further includes an extension member 350 that protrudes laterally from the base 330 in a direction generally perpendicular to the longitudinal axis of the rail 216 and generally perpendicular to the longitudinal axis of the base 330. A distal end of the extension member 350 includes a holder 348 that is configured to interface with the adapter 50 connected to the shower head 12 in the same manner as described above in relation to the holder 48. For completeness, it is noted that the holder 348 is essentially the same as the holder 48 and thus includes all the features described above in relation to the holder 48. Accordingly, for example, the holder 348 is rotatable about an axis generally perpendicular to a longitudinal axis of the extension member 350.

As is illustrated in FIG. 24, the base 330 further includes a roller 352 located generally adjacent to the forked section 332. The roller 352 protrudes at least partially outwardly from a rear surface of the base 330 and is configured to contact and roll upon a recessed section 217 (FIG. 20B) of the rail 216 as the base 330 is moved relative to the rail 216.

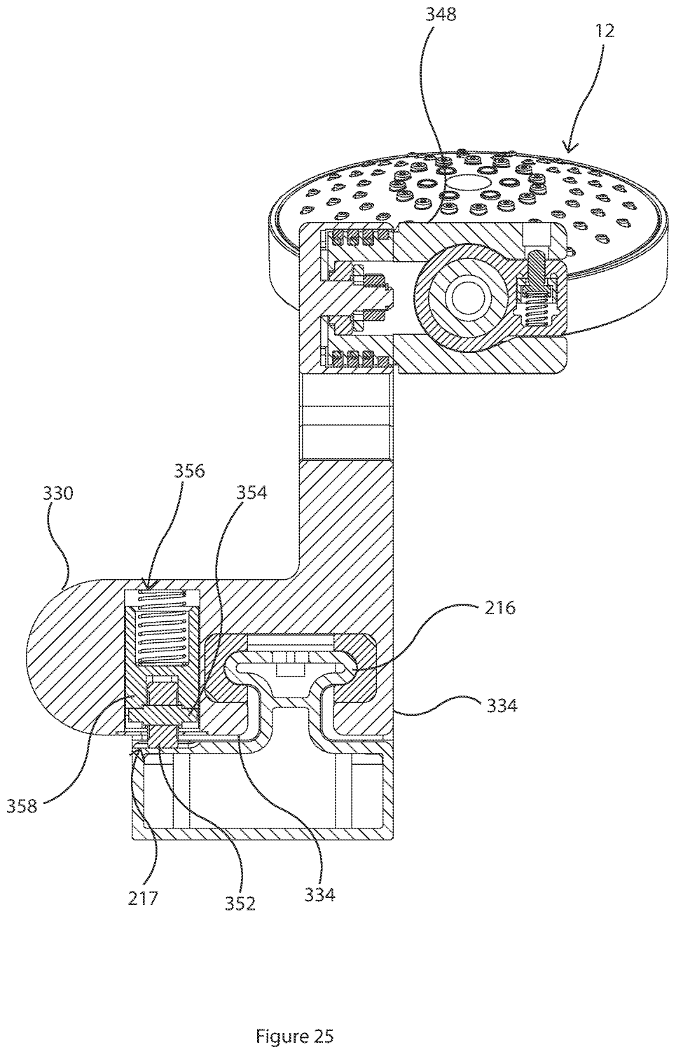

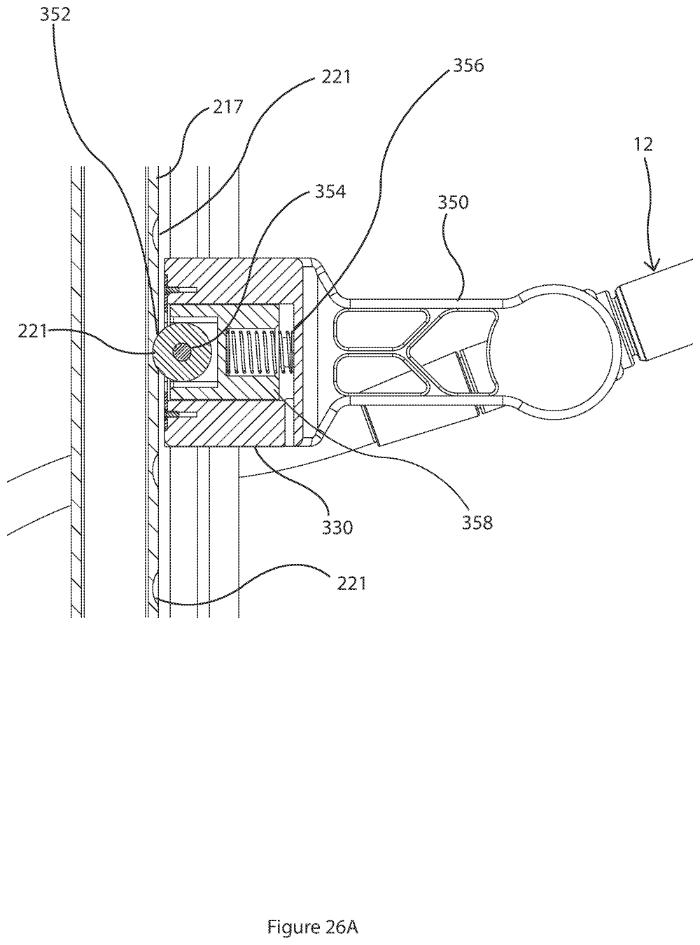

As is illustrated in the cross-sectional view in FIG. 25, the roller 352 rotates about an axle 354 that is arranged generally perpendicular to the longitudinal axis of the rail 217. The axle 354 is located within the base 330 and is biased outwardly by a compression spring 356 via engagement with a member 358 having an approximately H-shaped cross-section (when viewed from the top). Specifically, the ends of the H-shaped member 358 that are located relatively closer to the rail 217 engage the outer ends of the axle 354 to thereby move the axle 354 (and connected roller 352) to an extended position (illustrated in FIGS. 24 and 25). In the extended position, the roller 352 can at least partially engage within complimentary generally rectangular spaced-apart recesses 221 (FIG. 20B) located along the recessed rail section 217 as the base 330 is moved relative to the rail 216/217. The movement of the roller 352 along the rail 217 is also shown in the FIGS. 26A and 26B. In these figures it can be seen that the recesses 221 have an approximately semi-circular cross-section when viewed from the side. In FIG. 26A, the roller 352 is located at least partially within one of the recesses 221. In FIG. 26B, the roller 352 is removed from the recess 221 and is located in a retracted position engaging the flat surface of the rail 217 between adjacent spaced-apart recesses 221. It will be appreciated that the flat surface of the rail 217 acts to push the sprung roller 252 relatively away from the rail 217 (and inwardly into the base 330) against the bias of the spring 356. As shown in FIG. 24, as the cylindrical member 302 is pulled downwards by the user, the base 330 will move along the rail 216/217. The rigidity of member 302 means that the user can also push it upwards.

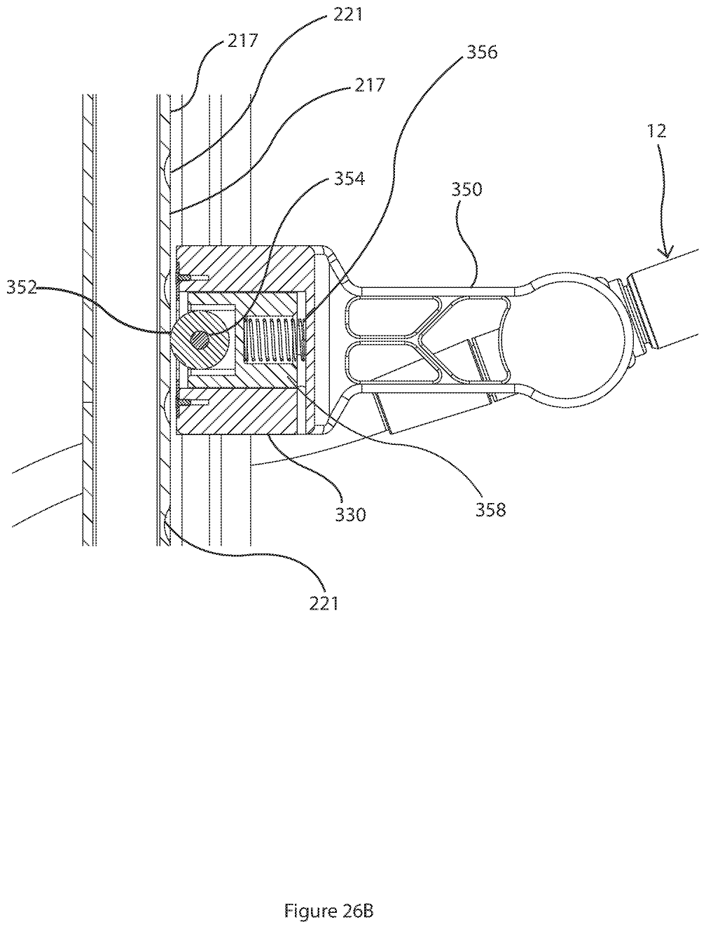

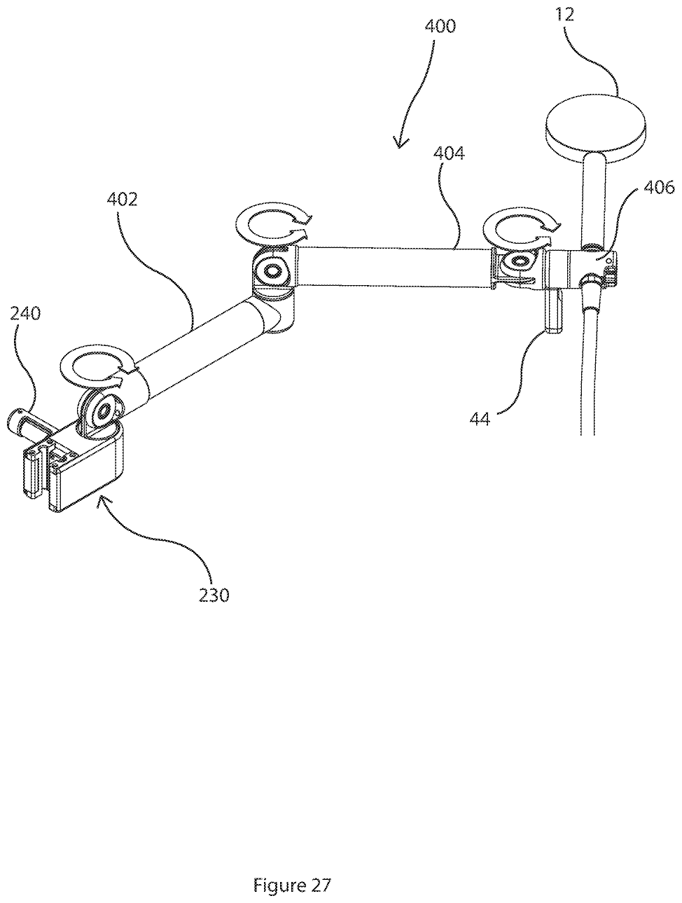

FIG. 27 illustrates a further alternative embodiment of the shower head holder 10. In this figure, the shower head holder device 400 includes the base 230 that is configured to engage and move along the rail 216 in the same manner as described above. The shower head holder 400 further includes a first arm 402 that is rotatably connected to the base 230 in the same manner as described above in relation to the arm 32 being rotatably connected to the base 30 of the device 10. The shower head holder 400 further includes a second arm 404 that is rotatably connected to a distal end of the first arm 402. Similar to the first arm 402, the second arm 404 is rotatably connected to the distal end of the first arm 402 in the same manner as described above in relation to the arm 32 being connected to the base 30. For completeness, it is noted that the first arm 402 may rotate about generally perpendicular vertical and horizontal axes with respect to the base 230, and the second arm 404 may rotate with respect to the distal end of the first arm 402 about generally perpendicular vertical and horizontal axes. The device 400 further includes a holder 406 that is rotatably connected to a distal end of the second arm 404 by a connection 408 that allows for rotation of the holder 406 about a generally vertical axis extending through the connection 408. Additionally, the holder 406 may include any one or more of the features described above in relation to the holder 48, and thus may interface with the adapter 50 connected to the shower head 12. Furthermore, the holder 406 may rotate about an axis generally parallel to the longitudinal axis of the second arm 404.

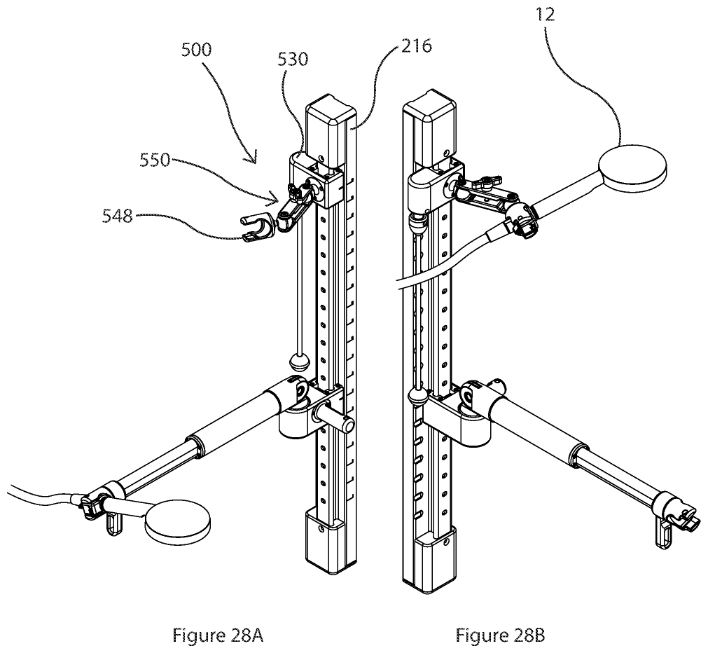

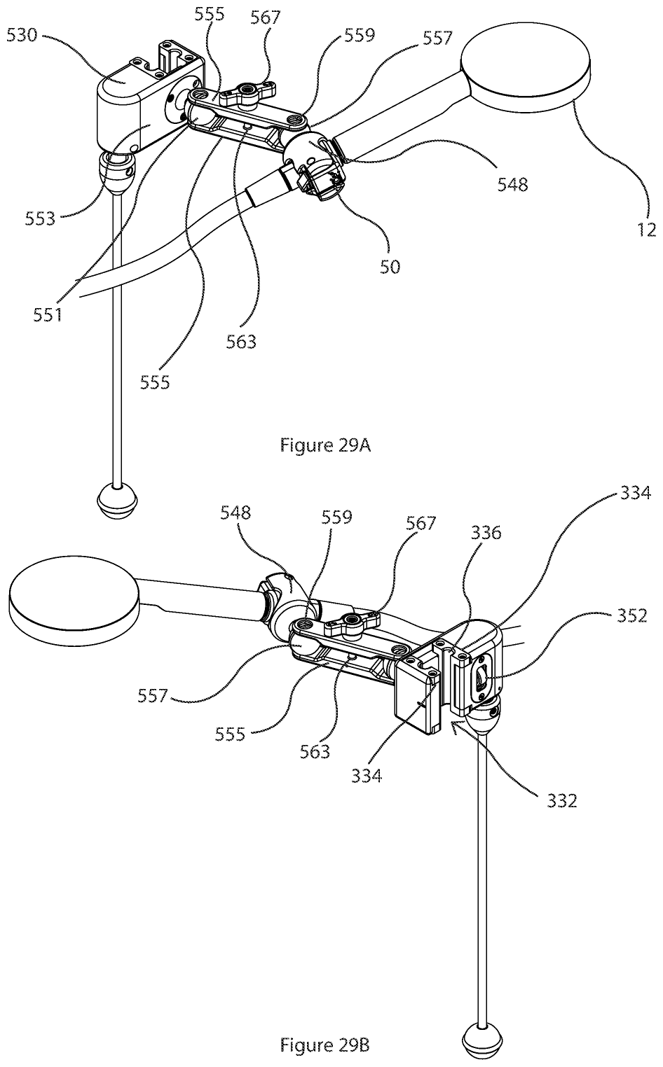

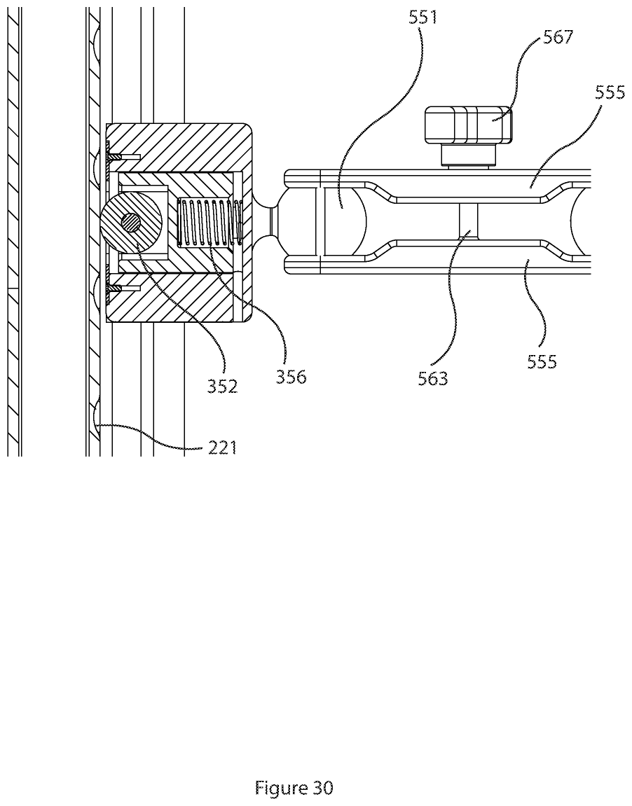

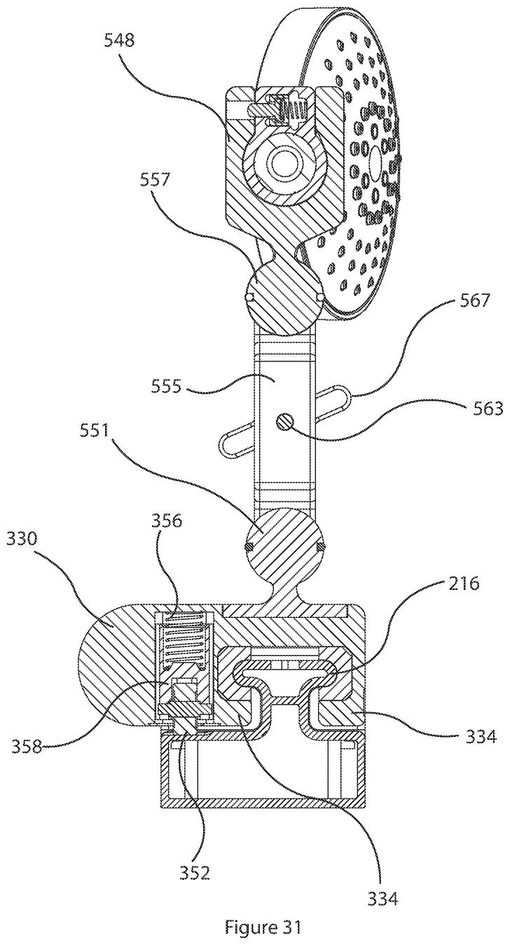

In an alternative embodiment shown in FIGS. 28A through 31, the shower head holder device 500 includes a base 530 that is similar to the base 330 shown in FIG. 24, in that it includes a forked section 332 defined by spaced-apart arms 334 (see FIG. 29B). The arms 334 include generally semi-circular recesses 336 extending along inner surfaces of the arms 334 to define a generally rectangular channel adapted to engage the rail 216 in the same manner as described above with respect to the base 230. The base 530 further includes a ball joint ball 551 that protrudes from the front face 553. An arm 550 comprising two longitudinal spaced apart members 555 protrudes from the base 530. A distal end of the arm 550 includes a holder 548 that is configured to interface with the adapter 50 connected to the shower head 12 in the same manner as described above in relation to the holder 48. The holder 548 includes a ball joint ball 557 that protrudes from an opposite side of the holder to the U-shaped portion created by upper arm portion 76 and lower arm portion 78. The two arms 555 include circular openings 559 at each end, although it will be appreciated that these may be depressions on their inner surfaces. The openings 559 seat about the respective two sides of the balls 551, 557 to hold them in position, whilst allowing rotational movement. A clamping arrangement is provided centrally, being a threaded bolt 563 that passed through aligned apertures 565 in the arms 555. A clamping actuator 567 is provided on one side that can be turned in one direction to draw the arms 555 together clamping the circular openings 559 against opposing sides of the balls 551, 557. Turning the clamping actuator 567 in the opposite direction allows the arms 555 to move apart releasing the clamping action and allowing the ball joints to rotate freely to the desired orientations, before tightening the clamp again so they hold the desired positions. As will be appreciated, the freedom of movement provided by two ball joints means that shower head can be positioned easily to almost any desired orientation.

The disclosure thus provides an improved shower head holding device that advantageously includes an adapter that is configured to releasably secure the shower head to the shower head holding device to prevent unintended or accidental removal of the shower head from the shower head holding device. The shower head holding device is may thus be manipulated without fear of the shower head becoming disconnected from the shower head holding device.

It will be understood that the invention disclosed and defined in this specification extends to all alternative combinations of two or more of the individual features mentioned or evident from the text or drawings. All of these different combinations constitute various alternative aspects of the invention.

1. A device for holding a shower head, the device comprising:
a base connectable to a support;
an arm connected to the base and configured to move with respect to the base about a first axis and about a second axis, wherein the first axis is generally perpendicular to the second axis;
an extension member supported by the arm and configured to extend relative to the arm; and
a holder connected to the extension member and configured to hold the shower head.

2. A device according to claim 1, further including an adapter connectable to the shower head and receivable by the holder so as to secure the shower head to the holder.

3. A device for holding a shower head, the device comprising:
a base connectable to a support;
an arm connected to the base and configured to rotate with respect to the base about at least a first axis and a second axis, wherein the first axis is generally perpendicular to the second axis;
a holder connected to the arm and configured to hold the shower head; and
an adapter connectable to the shower head and receivable by the holder so as to secure the shower head to the holder.

4. The device of claim 1, 2 or 3, wherein the holder is moveable relative to the extension member or arm about a third axis, wherein the third axis is generally perpendicular to each of the first and second axes.

5. A system comprising:
a shower head holder; and
an adapter connectable to a shower head, wherein the adapter is connectable to the shower head and receivable by the shower head holder so as to secure the shower head to the shower head holder.

6. A device according to any one of claims 1 to 4, or a system according to claim 5, wherein the adapter is configured to allow removal of the shower head from the holder only when a release means is selectively actuated.

7. A device according any one of claims 1 to 4, or a system according to claim 5, wherein the adapter includes an element that is configured to engage within the holder to secure the shower head to the holder.

8. A device according to claim 7 or a system according to claim 7, wherein the element is a moveable element that is configured to releasably engage within a complementary aperture within the holder.

9. A device according to any one of claims 1 to 4 and 6 to 8, wherein the holder is configured to move with respect to the extension member.

10. A device according to claim 9, wherein the holder is configured to rotate with respect to the extension member or arm about a third axis, the third axis generally perpendicular to the first and second axes.

11. A device according to any one of claims 1 to 4 and 6 to 8, wherein the arm is connected to the base with a ball joint connection.

12. A device according to claim 9 or 11, wherein the holder is connected to the extension member or arm with a ball joint connection.

13. A device according to any one of claims 1 to 4 and 6 to 12, or system according to any one of claims 5 to 8, further including one or more retarding mechanisms that act to retard the movement of the arm with respect to the base or to retard the movement of the holder with respect to the extension member or arm.

14. An adapter configured to secure a shower head to a shower head holder, the adapter comprising:
a body configured to be connected to the shower head; and
an element configured to engage the shower head holder to thereby secure the shower head to the shower head holder.

15. An adapter according to claim 14, further configured to allow removal of the shower head from the holder only when a release means is selectively actuated.
